(19) United States
(12) Patent Application Publication
(10) Pub. No.: US 2014/0192538 A1
(43) Pub. Date: Jul. 10, 2014

(54) POLYMER LIGHT ARMATURE

(71) Applicant: SABIC Innovative Plastics IP B.V., Bergen op Zoom (NL)

(72) Inventors: Mark Berix, Eindhoven (NL); Nela Stafie, Bergen op Zoom (NL); Hendrikus Petrus Cornelis van Heerbeek, Bergen op Zoom (NL); Frank Huijs, Breda (NL)

(73) Assignee: SABIC Innovative Plastics IP B.V., Bergen op Zoom (NL)

(21) Appl. No.: 14/150,314

(22) Filed: Jan. 8, 2014

Related U.S. Application Data
(60) Provisional application No. 61/750,009, filed on Jan. 8, 2013.

(51) Int. Cl. F21V 7/22; F21V 13/04

(52) U.S. Cl. CPC F21V 7/22; F21V 13/04
USPC 362/308; 362/341; 362/296.02; 524/537

(57) ABSTRACT

An armature for an illuminant can comprise: walls formed by an armature composition. The armature composition can comprise an armature polymer, 10 wt % to 20 wt % coated titanium dioxide, and greater than zero to 0.001 wt % carbon black, wherein the weight percentages are based upon a total weight of the armature composition. The armature polymer can comprise polycarbonate. At a thickness of greater than or equal to 3 mm, the armature has a reflection at 700 nm of greater than or equal to 93%. A light fixture can comprise a light source in the armature.

### CROSS-REFERENCE TO RELATED APPLICATION

This application claims priority to U.S. Provisional Application 61/750,009, filed Jan. 8, 2013, which is incorporated herein in its entirety.

### BACKGROUND OF THE INVENTION

This disclosure generally relates to light armatures, and more particularly to polymer light armatures.

Flame retardant (FR) polymers and polymer blends, for example polycarbonates and polycarbonate blends with UL V0 and 5V A and B Underwriters Laboratories flammability ratings are widely prepared and used, especially in a wide variety of electrical and electronic applications. Conversely, only a very limited set of polycarbonates are used in certain lighting applications, particularly armatures for lighting fixtures, and the like. All of these applications have stringent flammability safety requirements that the polycarbonates must meet. In addition, there are aesthetic requirements. For example, when used as an armature, the light from the light source should not be visible through the armature.

There continues to be a need in the art for polymer lighting armatures that are both flame retardant and aesthetically acceptable.

### SUMMARY

Disclosed herein are a polymer light armature and a light fixture comprising the armature.

In an embodiment, an armature for an illuminant can comprise: walls formed by an armature composition. The armature composition can comprise an armature polymer, 10 wt % to 20 wt % coated titanium dioxide, and greater than zero to 0.001 wt % carbon black, wherein the weight percentages are based upon a total weight of the armature composition. The armature polymer can comprise polycarbonate. At a thickness of greater than or equal to 3 mm, the armature has a reflection at 700 nm of greater than or equal to 93%.

In an embodiment, a light fixture can comprise a light source in the armature.

These and other non-limiting features and characteristics are more particularly described below.

### BRIEF DESCRIPTION OF THE FIGURES

Refer now to the figures, which are exemplary embodiments, and wherein the like elements are numbered alike

FIG. 1 is a graphical representation of carbon black loading versus transmission.

FIGS. 2-4 are perspective views of examples of light armatures.

FIG. 5 is a cross sectional view of another example of an armature illustrating light passing through the armature.

### DETAILED DESCRIPTION OF THE INVENTION

It has been discovered that the addition of carbon black to a light armature attains a desired reflection with no glow, e.g., at a thickness of greater than or equal to 4.0 millimeters (mm), specifically, greater than or equal to 3.0 mm, and more specifically, greater than or equal to 2.5 mm. The armature, at a thickness of greater than or equal to 3 mm (even at a thickness of greater than or equal to 1 mm), can have a reflection of greater than or equal to 93%, specifically, greater than or equal to 94%, more specifically, greater than or equal to 95%. As used herein, reflection is determined 700 nanometers (nm).

The armature compositions contain an armature polymer (e.g., a homopolycarbonate, copolycarbonate, etc.), coated titanium dioxide (TiO₂), and greater than zero to less than or equal to 0.001 wt % carbon black, based upon a total weight of the armature composition. For example, the armature composition contain 60 wt % to less than 90 wt % armature polymer (e.g., polycarbonate polymer), 10 wt % to 20 wt % coated titanium dioxide (TiO₂), and greater than zero to less than or equal to 0.001 wt % carbon black, and optional additives, based upon a total weight of the armature composition. The armature polymer can have a melt volume flow rate (MVR) of greater than or equal to 18 cubic centimeters per 10 minutes (cm³/10 min), specifically, greater than or equal to 20 cm³/10 min, as determined in accordance with ISO 1133.

Optionally, the armature polymer can contain a first polymer(s) comprising first repeating units and blocks of repeating polysiloxane units; and/or a brominated second polymer(s) different from the first polymer; and optionally, and/or third polymer(s) different from the first polymer and second polymer, wherein the weight percent (wt %) of the first polymer, second polymer, and optional one or more third polymers sum to 100 wt %, and the polysiloxane units are present in the composition in an amount of at least 0.3 wt %, based on the sum of the wt % of the first, second, and third polymers, and bromine is present in the composition in an amount of at least 7.8 wt %, based on the sum of the wt % of the first, second, and optional third polymers. An article molded from the composition can have an OSU integrated 2 minute heat release test value of less than 65 kW-min/m² and a peak heat release rate of less than 65 kW/m² as measured using the method of FAR F25.4, in accordance with Federal Aviation Regulation FAR 25.853 (d), and an E662 smoke test DsMax value of less than 200 when measured at a thickness of 1.6 mm. For simplicity, this test can be referred to herein as the “smoke density test.”

The first, second, and optionally one or more third polymers can be further selected and used in amounts effective to satisfy the requirements for heat release rates described in FAR F25.4 (Federal Aviation Regulations Section 25, Appendix F, Part IV). Materials in compliance with this standard are required to have a 2-minute integrated heat release rate of less than or equal to 65 kilowatt-minutes per square meter (kW-min/m²) and a peak heat release rate of less than 65 kilowatts per square meter (kW/m²) determined using the Ohio State University calorimeter, abbreviated as OSU 65/65 (2 min/peak). In applications requiring a more stringent standard, where a better heat release rate performance is called for, a 2-minute integrated heat release rate of less than or equal to 55 kW-min/m² and a peak heat release rate of less than 55 kW/m² (abbreviated as OSU 55/55) may be required.

The armature polymer can optionally comprise siloxane-containing copolymer can be present, e.g., in an amount of greater than or equal to 1 wt %, specifically 1 wt % to 85 wt % of the siloxane-containing copolymer, and an effective amount of the brominated polymer is at least 15 wt %, specifically 15 to 95 wt %, each based on the total weight of the first polymer, second polymer, and optional one or more third polymers.

The precise amount of the first polymer effective to provide at least 0.3 wt % of the polysiloxane units depends on the selected copolymer, the length of the siloxane block, the number the siloxane-containing blocks, and the desired properties, such as smoke density, heat release values, transparency, impact strength, melt viscosity, and/or other desired physical properties. In general, to be effective, when a block copolymer is used, the smaller the block size and/or the lower the number of blocks in the first polymer, the higher the fractional concentration of the first polymer, based on the total weight of the first, second and optionally one or more third polymers. When a graft copolymer is used, the lower the number of branches and/or the shorter the branches, the higher is the fractional concentration of the first polymer based on the total weight of the first, second and optionally one or more third polymers. Similarly, for the brominated polymer, the precise amount depends on the type of polymer, the amount of bromine in the polymer, and other desired characteristics of the compositions. The lower the weight percent of bromine in the second polymer, the higher the fractional concentration of the second polymer, based on the total weight of the first, second and optionally one or more third polymers. For example, the siloxane-containing copolymer can be at least 5 wt %, specifically 5 to 80 wt %, or at least 10 wt %, specifically 10 to 70 wt %, or at least 15 wt %, specifically 15 to 60 wt %, based upon the weight of the armature polymer. The brominated polymer can be at least 20 wt %, specifically 20 to 85 wt %, or 20 to 75 wt %, each based on the total weight of the armature polymer.

As stated above, the first polymer comprises first repeating units and blocks of repeating polysiloxane units. In a particularly advantageous feature, the first repeating units can be a variety of different units, which allows manufacture of low smoke, low heat release compositions having a variety of properties. The first repeating units can be polycarbonate units, etherimide units, ester units, sulfone units, ether sulfone units, arylene ether sulfone units, arylene ether units, and combinations comprising at least one of the foregoing, for example resorcinol-based aryl ester-carbonate units, etherimide-sulfone units, and arylene ether-sulfone units.

The first, second, and optional third polymers can be polycarbonates, that is, polymers containing repeating carbonate units. Thus the first polymer can be a poly(siloxane-carbonate) copolymer, the second polymer can be a brominated polymer containing repeating carbonate units, and the one or more optional third polymers can be polycarbonate homopolymers or copolymers. For example, the armature polymer can comprise at least 5 wt %, specifically 5 to 85 wt % of poly(siloxane-carbonate) copolymer, at least 15 wt %, specifically 15 to 95 wt % of brominated polycarbonate, such as a brominated polycarbonate derived from 2,2′,6,6′-tetrabromo-4,4′-isopropylidenediphenol (2,2-bis(3,5-dibromo-4-hydroxyphenyl)propane (TBBPA) and carbonate units derived from at least one dihydroxy aromatic compound that is not TBBPA (“TBBPA copolymer”), and 0 to 70 wt % of the optional one or more third polymers, based on the total weight of the armature polymer (i.e., the wt % of the first polymer, second polymer, and optional one or more third polymers sum to 100 wt %). The siloxane blocks present in the first polymer can have an average of 5 to 200 units, specifically 5 to 100, more specifically, 20 to 65 units. At least 0.3 wt % siloxane and at least 7.8 wt % bromine is present, each based on total weight of the armature polymer. The armature polymer can have an MVR of greater than or equal to 18 cm³/10 min.

When the siloxane blocks have an average of 25 to 75 units, specifically 25 to 50 units, and at least 2.0 wt % siloxane is present based on total weight of the armature polymer, excellent toughness is obtained. In particular, an article molded from the armature polymer can have a room temperature notched Izod impact of greater than or equal to 60 J/m² as measured according to ISO 180 at a 0.125 inch (3.2 mm) thickness. The articles can further have 100% ductility. The amount of siloxane in the composition can be varied by controlling the length of units per block, the number of blocks and the tacticity of the blocks along the backbone.

When the polysiloxane units of the first polymer is present in an amount of at least 2.0 wt % and the composition has 35 to 50 wt % of the second polymer (the TBBPA copolymer), each based on total weight of the armature polymer, and the siloxane blocks have an average length of 25 to 50 units, excellent transparency can be obtained.

Excellent transparency can also be obtained when the thermoplastic composition comprises the first polymer in an amount to provide at least 0.3 wt % siloxane and the second polymer in an amount to provide at least 5.0 wt % bromine, each based on total weight of the armature polymer, and the siloxane blocks or grafts have an average of 5 to 75, specifically 5 to 15 units. Amounts can be at least 30 wt %, specifically 30 to 80 wt % of the first polymer, and at least 20 wt %, specifically at least 20 to 50 wt % of the second polymer (the TBBPA copolymer), and 0 to 50 wt % (e.g., greater than zero to 50 wt %) of the optional one or more third polymers, each based on the total weight of the armature polymer.

It has been found that limiting the amount of the optional third polymer, together with use of specific first and second polycarbonates can produce compositions with advantageous properties. For example, the armature polymer can comprise the first polymer (the poly(siloxane-carbonate)), the second polymer (the TBBPA copolymer or brominated oligomer), and 8 to 12 wt % of the one or more third polymers, wherein the wt % of the first polymer, second polymer, and one or more third polymers sum to 100 wt % based on the total weight of the armature polymer. The siloxane blocks can have an average value of 20 to 85 units. At least 0.4 wt % of siloxane and at least 7.8 wt % of bromine can be present, each based on total weight of the armature polymer. For example, the armature polymer comprises 5 to 60 wt % of the first poly(siloxane-carbonate) 30 to 60 wt % of the second polymer (the TBBPA copolymer).

In the armature polymer, it has been found that other brominated oligomers can be used in place of the TBBPA copolymer, such as other brominated polycarbonate oligomers or brominated epoxy oligomers. These armature polymers can contain the first poly(siloxane-carbonate), a brominated oligomer, and an optional additional polycarbonate different from the first polymer and the brominated oligomer. The optional additional polycarbonate can be the same as the optional one or more third polymers described in the above embodiments. The first polymer, the brominated oligomer, and the optional additional polycarbonate are present in amounts to provide at least 0.4 wt % of siloxane and at least 7.8 wt % of bromine, each based on total weight of the armature polymer. In particular, the armature polymers can comprise at least 5 wt %, specifically 5 to 85 wt % of the first poly(siloxane-carbonate), at least 15 wt %, specifically at least 15 to 95 wt % of the brominated oligomer, and 0 to 60 wt % of the optional additional polycarbonate, each based on the total weight of the armature polymer. The siloxane blocks can have an average of 5 to 200, or 5 to 100 units.

While the smoke density and OSU tests demonstrate the ability of the poly(siloxane) copolymer compositions described herein to comply with both the smoke generation and heat release requirements for marine interiors, any of the above-described compositions can advantageously comply with other related flammability and safety tests as described above.

In certain embodiments, the first, optional second, and optional one or more third polymers, as well as the brominated polycarbonates (including the TBBPA copolymer and brominated polycarbonate oligomers) have repeating structural carbonate units of formula (1):

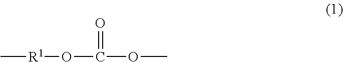

wherein at least 60%, specifically at least 80%, and specifically at least 90% of the total number of R¹ groups contains aromatic organic groups and the balance thereof are aliphatic or alicyclic groups. In particular, use of aliphatic groups is minimized in order to maintain the flammability performance of the polycarbonates. In an embodiment, at least 70%, at least 80%, or 95 to 100% of the R¹ groups are aromatic groups. In an embodiment, each R¹ is a divalent aromatic group, for example derived from an aromatic dihydroxy compound of formula (2)

HO-A¹-Y¹-A²-OH (2)

wherein each of A¹ and A² is independently a monocyclic divalent arylene group, and Y¹ is a single bond or a bridging group having one or two atoms that separate A¹ from A². In an embodiment, one atom separates A¹ from A². In another embodiment, when each of A¹ and A² is phenylene, Y¹ is para to each of the hydroxyl groups on the phenylenes. Illustrative non-limiting examples of groups of this type are —O—, —S—, —S(O)—, —S(O)₂—, —C(O)—, methylene, cyclohexyl-methylene, 2-[2.2.1]-bicycloheptylidene, ethylidene, isopropylidene, neopentylidene, cyclohexylidene, cyclopentadecylidene, cyclododecylidene, and adamantylidene. The bridging group Y¹ can be a hydrocarbon group, specifically a saturated hydrocarbon group such as methylene, cyclohexylidene, or isopropylidene.

Included within the scope of formula (2) are bisphenol compounds of formula (3)

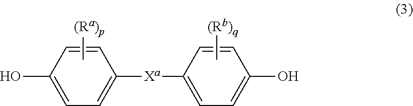

wherein each of R^{a} and R^{b} is independently a halogen atom or a monovalent hydrocarbon group; p and q are each independently integers of 0 to 4; and X^{a} represents a single bond or one of the groups of formulas (4) or (5)

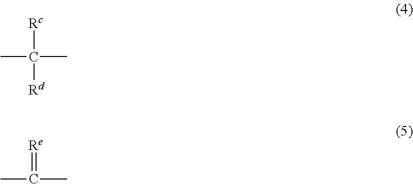

wherein each R^{c} and R^{d} is independently hydrogen, C₁₋₁₂ alkyl, C₁₋₁₂ cycloalkyl, C₇₋₁₂ arylalkyl, C₁₋₁₂ heteroalkyl, or cyclic C₇₋₁₂ heteroarylalkyl, and R^{e} is a divalent C₁₋₁₂ hydrocarbon group. In particular, R^{e} and R^{d} are each the same hydrogen or C₁₋₄ alkyl, specifically the same C₁₋₃ alkyl, even more specifically, methyl.

In an embodiment, R^{c} and R^{d} taken together is a C₃₋₂₀ cyclic alkylene or a heteroatom-containing C₃₋₂₀ cyclic alkylene comprising carbon atoms and heteroatoms with a valency of two or greater. These groups can be in the form of a single saturated or unsaturated ring, or a fused polycyclic ring system wherein the fused rings are saturated, unsaturated, or aromatic. A specific heteroatom-containing cyclic alkylene group comprises at least one heteroatom with a valency of 2 or greater, and at least two carbon atoms. Heteroatoms in the heteroatom-containing cyclic alkylene group include —O—, —S—, and —N(Z)—, where Z is a substituent selected from hydrogen, hydroxy, C₁₋₁₂ alkyl, C₁₋₁₂ alkoxy, or C₁₋₁₂ acyl.

In a specific embodiment, X^{a} is a substituted C₃₋₁₈ cycloalkylidene of formula (6)

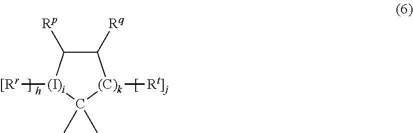

wherein each R^{r}, R^{p}, R^{q}, and R^{t} is independently hydrogen, halogen, oxygen, or C₁₋₁₂ organic group; I is a direct bond, a carbon, or a divalent oxygen, sulfur, or —N(Z)— wherein Z is hydrogen, halogen, hydroxy, C₁₋₁₂ alkyl, C₁₋₁₂ alkoxy, or C₁₋₁₂ acyl; h is 0 to 2, j is 1 or 2, i is an integer of 0 or 1, and k is an integer of 0 to 3, with the proviso that at least two of R^{r}, R^{p}, R^{q}, and R^{t} taken together are a fused cycloaliphatic, aromatic, or heteroaromatic ring. It will be understood that where the fused ring is aromatic, the ring as shown in formula (6) will have an unsaturated carbon-carbon linkage where the ring is fused. When k is 1 and i is 0, the ring as shown in formula (6) contains 4 carbon atoms, when k is 2, the ring as shown contains 5 carbon atoms, and when k is 3, the ring contains 6 carbon atoms. In an embodiment, two adjacent groups (e.g., R^{q} and R^{t} taken together) form an aromatic group, and in another embodiment, R^{q} and R^{t} taken together form one aromatic group and R^{r} and R^{p} taken together form a second aromatic group.

When k is 3 and i is 0, bisphenols containing substituted or unsubstituted cyclohexane units are used, for example bisphenols of formula (7)

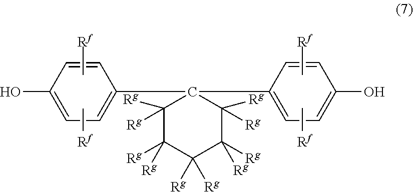

wherein R^{f} is each independently hydrogen, C₁₋₁₂ alkyl, or halogen; and R^{g} is each independently hydrogen or C₁₋₁₂ alkyl. The substituents can be aliphatic or aromatic, straight chain, cyclic, bicyclic, branched, saturated, or unsaturated. Such cyclohexane-containing bisphenols, for example the reaction product of two moles of a phenol with one mole of a hydrogenated isophorone, are useful for making polycarbonate polymers with high glass transition temperatures (T_{g}) and high heat distortion temperatures (HDT). Cyclohexyl bisphenol-containing polycarbonates, or a combination comprising at least one of the foregoing with other bisphenol polycarbonates, are supplied by Bayer Co. under the APEC* trade name.

Other useful dihydroxy compounds having the formula HO—R′—OH include aromatic dihydroxy compounds of formula (8)

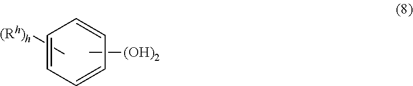

wherein R^{h} is each independently a halogen atom, a C₁₋₁₀ hydrocarbyl such as a C₁₋₁₀ alkyl group, a halogen substituted C₁₋₁₀ hydrocarbyl such as a halogen-substituted C₁₋₁₀ alkyl group, and h is 0 to 4. The halogen is usually bromine.

Some illustrative examples of dihydroxy compounds include the following: 4,4′-dihydroxybiphenyl, 1,6-dihydroxynaphthalene, 2,6-dihydroxynaphthalene, bis(4-hydroxyphenyl)methane, bis(4-hydroxyphenyl)diphenylmethane, bis(4-hydroxyphenyl)-1-naphthylmethane, 1,2-bis(4-hydroxyphenyl)ethane, 1,1-bis(4-hydroxyphenyl)-1-phenylethane, 2-(4-hydroxyphenyl)-2-(3-hydroxyphenyl)propane, bis(4-hydroxyphenyl)phenylmethane, 2,2-bis(4-hydroxy-3-bromophenyl)propane, 1,1-bis(hydroxyphenyl)cyclopentane, 1,1-bis(4-hydroxyphenyl)cyclohexane, 1,1-bis(4-hydroxyphenyl)isobutene, 1,1-bis(4-hydroxyphenyl)cyclododecane, trans-2,3-bis(4-hydroxyphenyl)-2-butene, 2,2-bis(4-hydroxyphenyl)adamantine, alpha,alpha′-bis(4-hydroxyphenyl)toluene, bis(4-hydroxyphenyl)acetonitrile, 2,2-bis(3-methyl-4-hydroxyphenyl)propane, 2,2-bis(3-ethyl-4-hydroxyphenyl)propane, 2,2-bis(3-n-propyl-4-hydroxyphenyl)propane, 2,2-bis(3-isopropyl-4-hydroxyphenyl)propane, 2,2-bis(3-sec-butyl-4-hydroxyphenyl)propane, 2,2-bis(3-t-butyl-4-hydroxyphenyl)propane, 2,2-bis(3-cyclohexyl-4-hydroxyphenyl)propane, 2,2-bis(3-allyl-4-hydroxyphenyl)propane, 2,2-bis(3-methoxy-4-hydroxyphenyl)propane, 2,2-bis(4-hydroxyphenyl)hexafluoropropane, 1,1-dichloro-2,2-bis(4-hydroxyphenyl)ethylene, 1,1-dibromo-2,2-bis(4-hydroxyphenyl)ethylene, 1,1-dichloro-2,2-bis(5-phenoxy-4-hydroxyphenyl)ethylene, 4,4′-dihydroxybenzophenone, 3,3-bis(4-hydroxyphenyl)-2-butanone, 1,6-bis(4-hydroxyphenyl)-1,6-hexanedione, ethylene glycol bis(4-hydroxyphenyl)ether, bis(4-hydroxyphenyl)ether, bis(4-hydroxyphenyl)sulfide, bis(4-hydroxyphenyl)sulfoxide, bis(4-hydroxyphenyl)sulfone, 9,9 to bis(4-hydroxyphenyl)fluorine, 2,7-dihydroxypyrene, 6,6′-dihydroxy-3,3,3′,3′-tetramethylspiro(bis)indane (“spirobiindane bisphenol”), 3,3-bis(4-hydroxyphenyl)phthalide, 2,6-dihydroxydibenzo-p-dioxin, 2,6-dihydroxythianthrene, 2,7-dihydroxyphenoxathin, 2,7-dihydroxy-9,10-dimethylphenazine, 3,6-dihydroxydibenzofuran, 3,6-dihydroxydibenzothiophene, and 2,7-dihydroxycarbazole, resorcinol, substituted resorcinol compounds such as 5-methyl resorcinol, 5-ethyl resorcinol, 5-propyl resorcinol, 5-butyl resorcinol, 5-t-butyl resorcinol, 5-phenyl resorcinol, 5-cumyl resorcinol, 2,4,5,6-tetrafluoro resorcinol, 2,4,5,6-tetrabromo resorcinol, and the like; catechol; hydroquinone; and substituted hydroquinones such as 2-methyl hydroquinone, 2-ethyl hydroquinone, 2-propyl hydroquinone, 2-butyl hydroquinone, 2-t-butyl hydroquinone, 2-phenyl hydroquinone, 2-cumyl hydroquinone, 2,3,5,6-tetramethyl hydroquinone, 2,3,5,6-tetra-t-butyl hydroquinone, 2,3,5,6-tetrafluoro hydroquinone, 2,3,5,6-tetrabromo hydroquinone, and the like. Combinations comprising at least one of the foregoing dihydroxy compounds can be used.

Specific examples of bisphenol compounds that can be represented by formula (3) include 1,1-bis(4-hydroxyphenyl)methane, 1,1-bis(4-hydroxyphenyl)ethane, 2,2-bis(4-hydroxyphenyl) propane (bisphenol A or BPA), 2,2-bis(4-hydroxyphenyl) butane, 2,2-bis(4-hydroxyphenyl)octane, 1,1-bis(4-hydroxyphenyl)propane, 1,1-bis(4-hydroxyphenyl)n-butane, 2,2-bis(4-hydroxy-1-methylphenyl)propane, 1,1-bis(4-hydroxy-t-butylphenyl) propane, 3,3-bis(4-hydroxyphenyl)phthalimidine, 2-phenyl-3,3-bis(4-hydroxyphenyl) phthalimidine (PPPBP), and 1,1-bis(4-hydroxy-3-methylphenyl)cyclohexane (DMBPC). Combinations comprising at least one of the foregoing dihydroxy compounds can also be used.

“Polycarbonate” as used herein includes homopolycarbonates, copolymers comprising different R¹ moieties in the carbonate (“copolycarbonates”), and copolymers comprising carbonate units and other types of polymer units, such as polysiloxane units or ester units. In a specific embodiment, the one or more optional third polymers is a linear homopolymer or copolymer comprising units derived from bisphenol A, in which each of A¹ and A² is p-phenylene and Y¹ is isopropylidene in formula (2). More specifically, at least 60%, particularly at least 80% of the R¹ groups in the polycarbonate homopolymer or copolymer are derived from bisphenol A. In an embodiment, the first polymer is a block or graft copolymer comprising carbonate units of formula (1) and blocks of polysiloxane units, i.e., a poly(siloxane-co-carbonate), referred to herein as a “poly(siloxane-carbonate).” Block poly(siloxane-carbonate) copolymers comprise siloxane blocks and carbonate blocks in the polymer backbone. Graft poly(siloxane-carbonate) copolymers are non-linear copolymers comprising the siloxane blocks connected to linear or branch polymer backbone comprising carbonate blocks.

In addition to the first repeating units in the first polymer (for example polycarbonate units (1) as described above), the first polymer comprises blocks of polysiloxane units of formula (9)

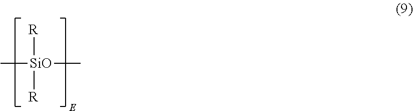

wherein R is each independently a C₁-C₃₀ hydrocarbon group, specifically a C₁₋₁₃ alkyl group, C₂₋₁₃ alkenyl group, C₃₋₆ cycloalkyl group, C₆₋₁₄ aryl group, C₇₋₁₃ arylalkyl group, or C₇₋₁₃ alkylaryl group. The foregoing groups can be fully or partially halogenated with fluorine, chlorine, bromine, or iodine, or a combination comprising at least one of the foregoing. Combinations of the foregoing R groups can be used in the same copolymer. In an embodiment, the polysiloxane comprises R groups that have minimum hydrocarbon content. In yet another embodiment, the foregoing R groups are functionalized wherein at least one methyl group has been replaced by another group, which is preferably not hydrogen, or wherein the functionalized R groups incorporate reactive functional groups such as anhydrides and epoxides that can react with other components by, for example, covalent bonding. In a specific embodiment, R is each the same and is a methyl group.

The average value of E in formula (9) can vary from 5 to 200. In an embodiment, E has an average value of 5 to 100, 10 to 100, 10 to 50, 25 to 50, or 35 to 50. In another embodiment, E has an average value of 5 to 75, specifically 5 to 15, specifically 5 to 12, more specifically 7 to 12. The siloxane blocks can be atactic, isotactic, or syndiotactic. In an embodiment, the tacticity of the siloxane can affect the effective amount of each copolymer used as well as the physico-chemical characteristic of the thermoplastic compositions formed (e.g., crystallinity, transparency, impact resistance and the like). The siloxane containing copolymer can be a graft copolymer wherein the siloxane-containing blocks are branched from a polymer backbone having blocks of the first repeating units, for example carbonate units of formula (1).

In an embodiment, for example in poly(siloxane-carbonates), the polysiloxane units can be derived from polysiloxane bisphenols of formula (10) or (11)

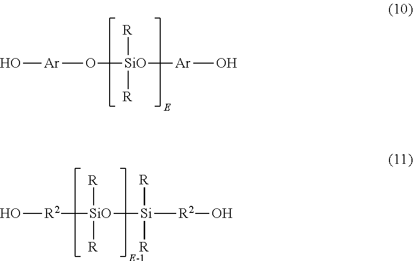

wherein E is as defined in formula (9); each R can be the same or different, and is as defined in formula (9); each Ar can be the same or different, and is a substituted or unsubstituted C₆₋₃₀ arylene group; and each R² is the same or different, and is a divalent C₁₋₃₀ alkylene or C₇₋₃₀ arylenealkylene wherein the bonds of the hydroxyl groups are directly bonded to the arylene moiety or the alkylene moiety.

The Ar groups in formula (10) can be derived from a C₆₋₃₀ dihydroxy aromatic compound, for example a dihydroxy aromatic compound of formula (2), (3), (6), (7), or (8) above. Combinations comprising at least one of the foregoing dihydroxy aromatic compounds can also be used. Illustrative examples of dihydroxy aromatic compounds are resorcinol (i.e., 1,3-dihydroxybenzene), 4-methyl-1,3-dihydroxybenzene, 5-methyl-1,3-dihydroxybenzene, 4,6-dimethyl-1,3-dihydroxybenzene, 1,4-dihydroxybenzene, 1,1-bis(4-hydroxyphenyl)methane, 1,1-bis(4-hydroxyphenyl)ethane, 2,2-bis(4-hydroxyphenyl) propane, 2,2-bis(4-hydroxyphenyl)butane, 2,2-bis(4-hydroxyphenyl)octane, 1,1-bis(4-hydroxyphenyl)propane, 1,1-bis(4-hydroxyphenyl)n-butane, 2,2-bis(4-hydroxy-1-methylphenyl)propane, 1,1-bis(4-hydroxyphenyl)cyclohexane, bis(4-hydroxyphenyl sulfide), and 1,1-bis(4-hydroxy-t-butylphenyl)propane. Combinations comprising at least one of the foregoing dihydroxy compounds can also be used. In an embodiment, the dihydroxy aromatic compound is unsubstituted, or is not substituted with non-aromatic hydrocarbon-containing substituents such as alkyl, alkoxy, or alkylene substituents.

In a specific embodiment, where Ar is derived from resorcinol, the polydiorganosiloxane repeating units are derived from polysiloxane bisphenols of formula (12)

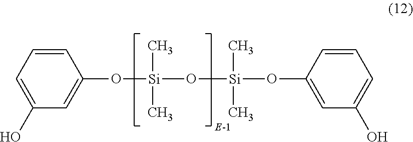

or, where Ar is derived from bisphenol A, from polysiloxane bisphenols of formula (13)

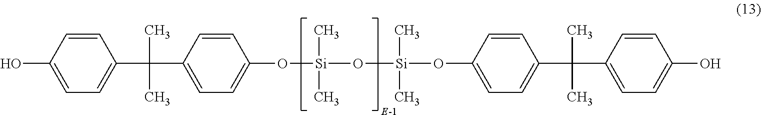

wherein E is as defined in formula (9) above.

Where R² is C₇₋₃₀ arylenealkylene in formula (11), the polysiloxane units can be derived from polysiloxane bisphenols of formula (14)

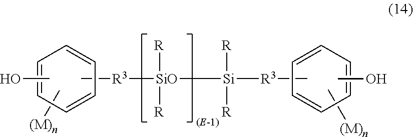

wherein R and E are as defined in formula (9). R³ is each independently a divalent C₂₋₈ aliphatic group. Each M can be the same or different, and can be a halogen, cyano, nitro, C₁₋₈ alkylthio, C₁₋₈ alkyl, C₁₋₈ alkoxy, C₂₋₈ alkenyl, C₂₋₈ alkenyloxy group, C₃₋₈ cycloalkyl, C₃₋₈ cycloalkoxy, C₆₋₁₀ aryl, C₆₋₁₀ aryloxy, C₇₋₁₂ arylalkyl, C₇₋₁₂ arylalkoxy, C₇₋₁₂ alkylaryl, or C₇₋₁₂ alkylaryloxy, wherein each n is independently 0, 1, 2, 3, or 4. In an embodiment, M is bromo or chloro, an alkyl such as methyl, ethyl, or propyl, an alkoxy such as methoxy, ethoxy, or propoxy, or an aryl such as phenyl, chlorophenyl, or tolyl; R³ is a dimethylene, trimethylene or tetramethylene group; and R is a C₁₋₈ alkyl, haloalkyl such as trifluoropropyl, cyanoalkyl, or aryl such as phenyl, chlorophenyl or tolyl. In another embodiment, R is methyl, or a combination of methyl and trifluoropropyl, or a combination of methyl and phenyl. In still another embodiment, M is methoxy, n is 0 or 1, R³ is a divalent C₁₋₃ aliphatic group, and R is methyl.

In a specific embodiment, the polysiloxane units are derived from a polysiloxane bisphenol of formula (15)

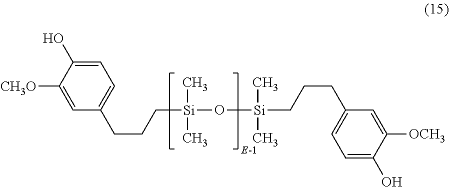

wherein E is as described in formula (9).

In another specific embodiment, the polysiloxane units are derived from polysiloxane bisphenol of formula (16)

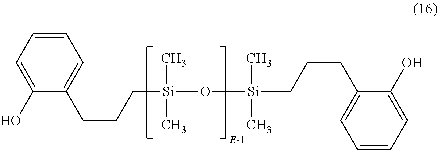

wherein E is as described in formula (9).

The relative amount of carbonate and polysiloxane units in the poly(siloxane-carbonate) will depend on the desired properties, and are carefully selected using the guidelines provided herein. In particular, as mentioned above, the block or graft poly(siloxane-carbonate) copolymer is selected to have a certain average value of E, and is selected and used in amount effective to provide the desired wt % of polysiloxane units in the composition. In an embodiment, the poly(siloxane-carbonate) can comprise polysiloxane units in an amount of 0.3 to 30 weight percent (wt %), specifically 0.5 to 25 wt %, or 0.5 to 15 wt %, or even more specifically 0.7 to 8 wt %, or 0.7 to 7 wt %, based on the total weight of the poly(siloxane-carbonate), with remainder being carbonate units. In another embodiment, the poly(siloxane-carbonate) can comprise polysiloxane units in an amount of 0.5 to 25 weight percent (wt %), specifically 0.5 to 20 wt %, or 0.5 to 10 wt % based on the total weight of the poly(siloxane-carbonate), with remainder being carbonate units.

In an embodiment, the poly(siloxane-carbonate) comprises units derived from polysiloxane bisphenols (14) as described above, specifically wherein M is methoxy, n is 0 or 1, R³ is a divalent C₁₋₃ aliphatic group, and R is methyl, still more specifically a polysiloxane bisphenol of formula (15) or (16). In these embodiments, E can have an average value of 5 to 200, or 8 to 100, wherein the polysiloxane units are present in an amount of 0.3 to 25 wt % based on the total weight of the poly(siloxane-carbonate); or, in other embodiments, E can have an average value of 25 to 100, wherein the polysiloxane units are present in an amount of 5 to 30 wt % based on the total weight of the poly(siloxane-carbonate); or E can have an average value of 30 to 50, or 40 to 50, wherein the polysiloxane units are present in an amount of 4 to 8 wt % based on the total weight of the poly(siloxane-carbonate); or E can have an average value of 5 to 12, wherein the polysiloxane units are present in an amount of 0.5 to 7 wt % based on the total weight of the poly(siloxane-carbonate). In other embodiments, specifically those used in translucent, high clarity, medium clarity, high impact, and colored marine vehicle articles, E can have an average value of 5 to 200, or 8 to 100, wherein the polysiloxane units are present in an amount of 0.5 to 25 wt % based on the total weight of the poly(siloxane-carbonate); or, in other embodiments, E can have an average value of 25 to 65, wherein the polysiloxane units are present in an amount of 15 to 25 wt % based on the total weight of the poly(siloxane-carbonate); or E can have an average value of 20 to 65, or 40 to 65, wherein the polysiloxane units are present in an amount of 4 to 25 wt % based on the total weight of the poly(siloxane-carbonate); or E can have an average value of 5 to 12, wherein the polysiloxane units are present in an amount of 0.5 to 7 wt % based on the total weight of the poly(siloxane-carbonate).

In another embodiment, the first polymer is a poly(siloxane-etherimide) copolymer comprising siloxane blocks (9) and polyetherimide units of formula (17)

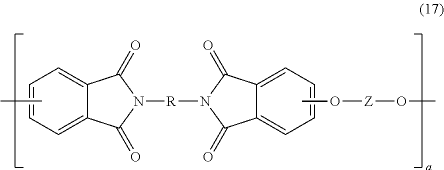

wherein a is 1 or greater than 1, for example 5 to 1,000 or more, or more specifically 10 to 500. In this embodiment, the first polymer is a block or graft copolymer comprising etherimide units of formula (17) and blocks of polysiloxane units, i.e., a poly(siloxane-co-etherimide), referred to herein as a “(polyetherimide-siloxane).” Block poly(siloxane-etherimide) copolymers comprise siloxane blocks and etherimide blocks in the polymer backbone. The siloxane blocks and the polyetherimide units can be present in random order, as blocks (i.e., AABB), alternating (i.e., ABAB), or a combination thereof. Graft poly(siloxane-etherimide) copolymers are non-linear copolymers comprising the siloxane blocks connected to linear or branch polymer backbone comprising etherimide blocks.

The group R in formula (17) is a divalent hydrocarbon group, such as a C₆₋₂₀ aromatic hydrocarbon group or halogenated derivative thereof, a straight or branched chain C₂₋₂₀ alkylene group or halogenated derivative thereof, a C₃₋₂₀ cycloalkylene group or halogenated derivative thereof, or a divalent group of formula (18)

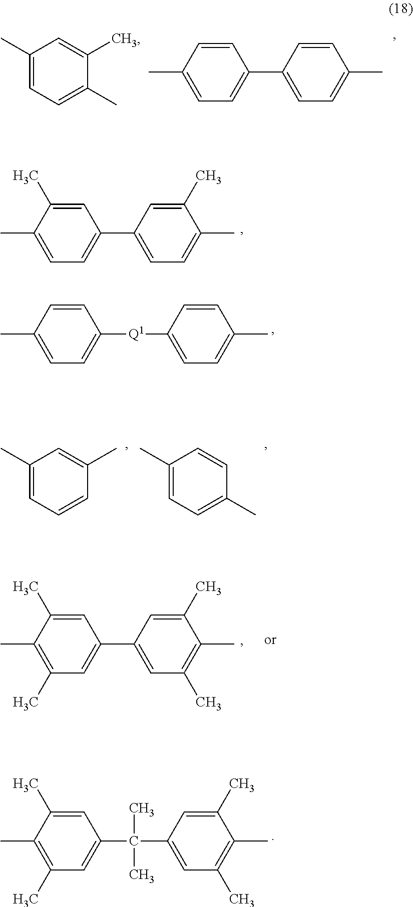

wherein Q¹ is —O—, —S—, —C(O)—, —SO₂—, —SO—, and —C_{y}H_{2y}— and a halogenated derivative thereof (which includes perfluoroalkylene groups) wherein y is an integer from 1 to 5. In a specific embodiment R is a m-phenylene or p-phenylene.

The group Z in formula (17) is also a divalent hydrocarbon group, and can be an aromatic C₆₋₂₄ monocyclic or polycyclic moiety optionally substituted with 1 to 6 C₁₋₈ alkyl groups, 1 to 8 halogen atoms, or a combination thereof, provided that the valence of Z is not exceeded. Exemplary groups Z include groups derived from a dihydroxy compound of formula (3). A specific example of a group Z is a divalent group of formula (19)

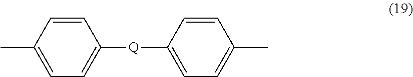

wherein Q is —O—, —S—, —C(O)—, —SO₂—, —SO—, and —C_{y}H_{2y}— and a halogenated derivative thereof (including a perfluoroalkylene group) wherein y is an integer from 1 to 5. In a specific embodiment Z is derived from bisphenol A wherein Q is 2,2-isopropylidene.

More specifically, the first polymer comprises blocks of 10 to 1,000 or 10 to 500 structural units of formula (17) wherein R is a divalent group of formula (19) wherein Q¹ is —C_{y}H_{2y}— wherein y is an integer from 1 to 5 or a halogenated derivative thereof, and Z is a group of formula (19). In a specific embodiment, R is m-phenylene, p-arylene diphenylsulfone, or a combination thereof, and Z is 2,2-(4-phenylene)isopropylidene.

As is known, polyetherimides can be obtained by polymerization of an aromatic bisanhydride of the formula (20)

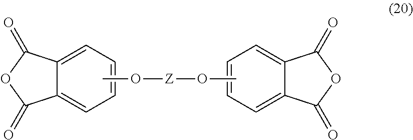

wherein Z is as described in formula (17), with a diamine of the formula (21)

H₂N—R—NH₂ (21)

wherein R is as described in formula (17). Illustrative examples of the aromatic bisanhydrides (20) include 3,3-bis[4-(3,4-dicarboxyphenoxy)phenyl]propane dianhydride; 4,4′-bis(3,4-dicarboxyphenoxy)diphenyl ether dianhydride; 4,4′-bis(3,4-dicarboxyphenoxy)diphenyl sulfide dianhydride; 4,4′-bis(3,4-dicarboxyphenoxy)benzophenone dianhydride; 4,4′-bis(3,4-dicarboxyphenoxy)diphenyl sulfone dianhydride; 2,2-bis[4-(2,3-dicarboxyphenoxy)phenyl]propane dianhydride; 4,4′-bis(2,3-dicarboxyphenoxy)diphenyl ether dianhydride; 4,4′-bis(2,3-dicarboxyphenoxy)diphenyl sulfide dianhydride; 4,4′-bis(2,3-dicarboxyphenoxy)benzophenone dianhydride; 4,4′-bis(2,3-dicarboxyphenoxy)diphenyl sulfone dianhydride; 4-(2,3-dicarboxyphenoxy)-4′-(3,4-dicarboxyphenoxy)diphenyl-2,2-propane dianhydride; 4-(2,3-dicarboxyphenoxy)-4′-(3,4-dicarboxyphenoxy)diphenyl ether dianhydride; 4-(2,3-dicarboxyphenoxy)-4′-(3,4-dicarboxyphenoxy)diphenyl sulfide dianhydride; 4-(2,3-dicarboxyphenoxy)-4′-(3,4-dicarboxyphenoxy)benzophenone dianhydride and 4-(2,3-dicarboxyphenoxy)-4′-(3,4-dicarboxyphenoxy)diphenyl sulfone dianhydride. Combinations comprising at least one of the foregoing aromatic bisanhydrides (20) can be used.

Illustrative examples of diamines (21) include ethylenediamine, propylenediamine, trimethylenediamine, diethylenetriamine, triethylenetetramine, hexamethylenediamine, heptamethylenediamine, octamethylenediamine, nonamethylenediamine, decamethylenediamine, 1,12-dodecanediamine, 1,18-octadecanediamine, 3-methylheptamethylenediamine, 4,4-dimethylheptamethylenediamine, 4-methylnonamethylenediamine, 5-methylnonamethylenediamine, 2,5-dimethylhexamethylenediamine, 2,5-dimethylheptamethylenediamine, 2,2-dimethylpropylenediamine, N-methyl-bis(3-aminopropyl)amine, 3-methoxyhexamethylenediamine, 1,2-bis(3-aminopropoxy)ethane, bis(3-aminopropyl) sulfide, 1,4-cyclohexanediamine, bis-(4-aminocyclohexyl)methane, m-phenylenediamine, p-phenylenediamine, 2,4-diaminotoluene, 2,6-diaminotoluene, m-xylylenediamine, p-xylylenediamine, 2-methyl-4,6-diethyl-1,3-phenylene-diamine, 5-methyl-4,6-diethyl-1,3-phenylene-diamine, benzidine, 3,3′-dimethylbenzidine, 3,3′-dimethoxybenzidine, 1,5-diaminonaphthalene, bis(4-aminophenyl)methane, bis(2-chloro-4-amino-3,5-diethylphenyl) methane, bis(4-aminophenyl)propane, 2,4-bis(amino-t-butyl)toluene, bis(p-amino-t-butylphenyl)ether, bis(p-methyl-o-aminophenyl)benzene, bis(p-methyl-o-aminopentyl) benzene, 1,3-diamino-4-isopropylbenzene, bis(4-aminophenyl) sulfide, his (4-aminophenyl) sulfone, bis(4-aminophenyl)ether and 1,3-bis(3-aminopropyl)tetramethyldisiloxane. Combinations comprising at least one of the foregoing aromatic bisanhydrides can be used. Aromatic diamines are often used, especially m- and p-phenylenediamine, sulfonyl dianiline and combinations thereof.

The poly(siloxane-etherimide)s can be formed by polymerization of an aromatic bisanhydride (20) and a diamine component comprising an organic diamine (21) or mixture of diamines (21), and a polysiloxane diamine of formula (22)

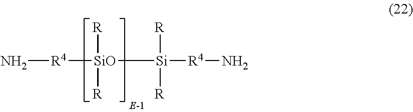

wherein R and E are as described in formula (9), and R⁴ is each independently a C₂-C₂₀ hydrocarbon, in particular a C₂-C₂₀ arylene, alkylene, or arylenealkylene group. In an embodiment R⁴ is a C₂-C₂₀ alkyl group, specifically a C₂-C₂₀ alkyl group such as propylene, and E has an average value of 5 to 100, 5 to 75, 5 to 60, 5 to 15, or 15 to 40. Procedures for making the polysiloxane diamines of formula (22) are well known in the art. For example, an aminoorganotetraorganodisiloxane can be equilibrated with an octaorganocyclotetrasiloxane, such as octamethylcyclotetrasiloxane, to increase the block length of the polydiorganosiloxane.

In some poly(siloxane-etherimide)s the diamine component can contain 20 to 50 mole percent (mol %), or 25 to 40 mol % of polysiloxane diamine (22) and about 50 to 80 mol %, or 60 to 75 mol % of diamine (21), for example as described in U.S. Pat. No. 4,404,350. The diamine components can be physically mixed prior to reaction with the bisanhydride(s), thus forming a substantially random copolymer. Alternatively, block or alternating copolymers can be formed by selective reaction of (21) and (22) with aromatic dianhydrides (20), to make polyimide blocks that are subsequently reacted together. Thus, the poly(siloxane-imide) copolymer can be a block, random, or graft copolymer.

In an embodiment, the poly(siloxane-etherimide) is made by sequentially intercondensing at temperatures in the range of 100° C. to 300° C., the polysiloxane diamine (22) and the diamine (21) with aromatic bisanhydride (20). A substantially inert organic solvent can be used to facilitate intercondensation, for example, dipolar aprotic solvents such as dimethylformamide, N-methyl-2-pyrrolidone, cresol, ortho-dichlorobenzene, and the like. A polymerization catalyst can be used at 0.025 to 1.0% by weight, based on the weight of the reaction mixture, such as an alkali metal aryl phosphinate or alkali metal aryl phosphonate, for example, sodium phenylphosphinate.

The sequential intercondensation of the polysiloxane diamine (22) and the diamine (21) with the aromatic bisanhydride (20) can be achieved in either a single container or in multiple containers. In the “single pot” procedure, an off stoichiometric amount of either the polysiloxane diamine (22) or the diamine (21), is intercondensed with the aromatic bisanhydride (20) in the presence of an inert organic solvent to produce a mixture of polyimide oligomer chain stopped with either intercondensed diamine or aromatic bisanhydride. An excess of aromatic bisanhydride (2) or diamine (21) corresponding to the chain stopping units also can be present. The oligomer can be either a silicone polyimide, or an oligomer of intercondensed aromatic bisanhydride and diamine. There is then added to the same pot, after the initial period of oligomer formation, the remaining diamine, which can be either the polysiloxane diamine (22) or the diamine (21) and optionally sufficient aromatic bisanhydride (20) to achieve stoichiometry. There also can be added to the resulting intercondensation mixture, chain stoppers, such a phthalic anhydride or monofunctional arylamine such as aniline to control the molecular weight of the 55 final silicone polyimide. In the multiple pot procedure, diamine oligomer and polysiloxane diamine oligomer can be intercondensed with aromatic bisanhydride in separate containers. The multiple pot procedure can achieve satisfactory results in instances where two or more oligomers are required providing a substantially stoichiometric balance maintained between total aromatic bisanhydride and diamine.

Oligomer block size can vary depending upon the proportions of polysiloxane diamine (22) and the diamine (21) used, per mole of aromatic bisanhydride (20). For example, for a “three block,” oligomer, a 4/3 ratio can be used, i.e. 4 moles of diamine for 3 moles of bisanhydride. Reaction can continue until the intercondensation of anhydride and amine functional groups are achieved and the water of reaction is completely removed, such as by azeotroping from the reaction mixture.

Examples of such poly(siloxane-etherimide) are described in U.S. Pat. Nos. 4,404,350, 4,808,686, and 4,690,997. In an embodiment, the poly(siloxane-etherimide) has units of formula (23)

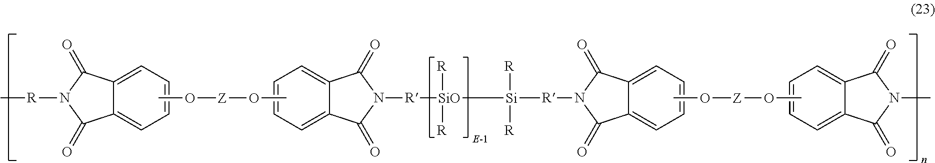

wherein E is as in formula (9), R and Z are as in formula (17), R⁴ is as in formula (22), and n is an integer from 5 to 100.

It is also possible to incorporate polysiloxane units into a poly(siloxane-etherimide) by reaction of diamine (21) with an anhydride component comprising aromatic anhydride (20) and a polysiloxane dianhydride of formula (24), a siloxane dianhydride of formula (25), or a combination thereof

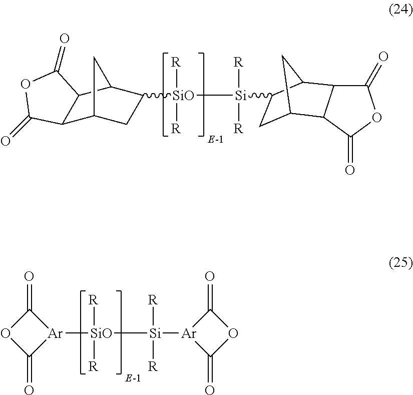

wherein R and E are as described in structure (9) and each Ar is independently a C₆-C₃₀ aromatic group. In some poly(siloxane-etherimide)s the dianhydride component can contain 20 to 50 mole percent (mol %), or 25 to 40 mol % of polysiloxane dianhydride (24) and/or (25) and about 50 to 80 mol %, or 60 to 75 mol % of dianhydride (20), for example as described in U.S. Pat. No. 4,404,350. The anhydride components can be physically mixed prior to reaction with the diamine(s), thus forming a substantially random copolymer. Alternatively, block or alternating copolymers can be formed by selective reaction of anhydrides (20) and (24) and/or (25) with diamine (21), to make polyimide blocks that are subsequently reacted together.

The relative amount of polysiloxane units and etherimide units in the poly(siloxane-etherimide) depends on the desired properties, and are carefully selected using the guidelines provided herein. In particular, as mentioned above, the block or graft poly(siloxane-etherimide) copolymer is selected to have a certain average value of E, and is selected and used in amount effective to provide the desired wt % of polysiloxane units in the composition. In an embodiment the poly(siloxane-etherimide) comprises 10 to 50 wt %, 10 to 40 wt %, or 20 to 35 wt % polysiloxane units, based on the total weight of the poly(siloxane-etherimide).

Other poly(siloxane) copolymers include poly(siloxane-sulfone) copolymers such as poly(siloxane-arylene sulfone)s and poly(siloxane-arylene ether sulfone)s wherein the first repeating units are units of formula (26)

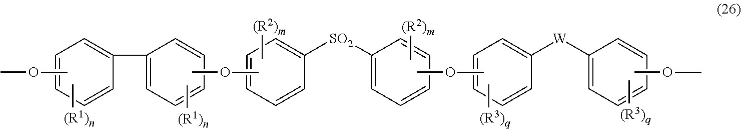

wherein R¹, R², and R³ are each independently a halogen atom, a nitro group, a cyano group, a C₁₋₁₂ aliphatic radical, C₃₋₁₂ cycloaliphatic radical, or a C₃₋₁₂ aromatic radical; n, m, q are each independently 0 to 4; and W is a C₃₋₂₀ cycloaliphatic radical or a C₃-C₂₀ aromatic radical. In an embodiment, the first units (26) contain at least 5 mol % of aromatic ether units of formula (27)

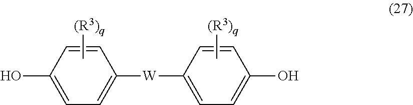

wherein R³ and W are as defined in formula (26). In an embodiment, n, m, and q are each 0 and W is isopropylidene. These poly(siloxane-sulfone) copolymers may be made by reaction of arylene sulfone-containing, arylene ether-containing, or arylene ether sulfone-containing oligomers with functionalized polysiloxanes to form random or block copolymers. Examples of the poly(siloxane-sulfones and their manufacture, in particular poly(siloxane-arylene sulfone)s and poly(siloxane-arylene ether sulfone)s, are disclosed in U.S. Pat. Nos. 4,443,581, 3,539,657, 3,539,655, and 3,539,655.

The relative amount of polysiloxane units and arylene sulfone units or arylene ether sulfone units in the poly(siloxane-sulfone) copolymers depends on the desired properties, and are carefully selected using the guidelines provided herein. In particular, the block or graft poly(siloxane-sulfone) is selected and used in amount effective to provide the desired wt % of polysiloxane units in the composition. In an embodiment the poly(siloxane-arylene ether sulfone) comprises 10 to 50 wt %, 10 to 35 wt %, or 10 to 30 wt % polysiloxane units, based on the total weight of the poly(siloxane-arylene ether sulfone).

Other poly(siloxane) copolymers include poly(siloxane-arylene ether)s wherein the first repeating units are blocks of units of formula (28)

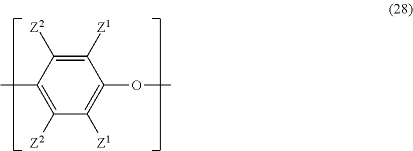

wherein Z¹ is each independently halogen or C₁-C₁₂ hydrocarbon group with the proviso that that the hydrocarbon group is not tertiary hydrocarbon group; and Z² is each independently hydrogen, halogen, or C₁-C₁₂ hydrocarbon group with the proviso that that the hydrocarbon group is not tertiary hydrocarbyl. In an embodiment, Z² is hydrogen and Z¹ is methyl.

Poly(siloxane-arylene ether)s and methods for the manufacture of poly(siloxane-arylene ether)s have been described in U.S. Pat. No. 5,204,438, which is based on the conversion of phenol-siloxane macromers to a silicone polyphenylene ether graft copolymer; and in U.S. Pat. No. 4,814,392. U.S. Pat. No. 5,596,048 discloses reaction of a polyarylene ether with a hydroxyaromatic terminated siloxane in the presence of an oxidant.

The relative amount of polysiloxane units and arylene ether units in the poly(siloxane-arylene ether) depends on the desired properties, and are carefully selected using the guidelines provided herein. In particular, the block or graft poly(siloxane-arylene ether) copolymer is selected and used in amount effective to provide the desired wt % of polysiloxane units in the composition. In an embodiment the poly(siloxane-arylene ether) comprises 1 to 80 wt %, 5 to 50 wt %, 10 to 35 wt %, or 10 to 30 wt % polysiloxane units, based on the total weight of the poly(siloxane-arylene ether).

Other poly(siloxane) copolymers include poly(siloxane-arylene ether ketone)s wherein the first repeating units are units of formula (29)

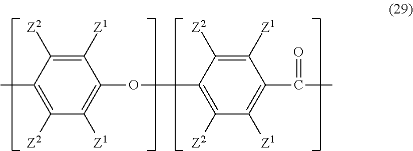

wherein Z¹ is each independently halogen or C₁-C₁₂ hydrocarbon group with the proviso that that the hydrocarbon group is not tertiary hydrocarbon group; and Z² is each independently hydrogen, halogen, or C₁-C₁₂ hydrocarbon group with the proviso that the hydrocarbon group is not tertiary hydrocarbyl. In an embodiment Z² and Z¹ are hydrogen. The arylene ether units and arylene ketone units can be present in random order, as blocks (i.e., AABB, or alternating (i.e., ABAB), or a combination thereof.

The relative amount of polysiloxane units and arylene ether ketone units in the poly(siloxane-arylene ether ketone) depends on the desired properties, and are carefully selected using the guidelines provided herein. In particular, the block or graft poly(siloxane-arylene ether ketone) copolymer is selected and used in amount effective to provide the desired wt % of polysiloxane units in the composition. In an embodiment the poly(siloxane-arylene ether ketone) comprises 5 to 50 wt %, 10 to 35 wt %, or 10 to 30 wt % polysiloxane units, based on the total weight of the poly(siloxane-arylene ether ketone).

Poly(siloxane-esters), including poly(siloxane-ester-carbonate) copolymers can be used provided that the ester units are selected so as to not significantly adversely affect the desired properties of the poly(siloxane) copolymer compositions, in particular low smoke density and low heat release, as well as other properties such as stability to UV light. For example, aromatic ester units can diminish color stability of the poly(siloxane) copolymer compositions during processing and when exposed to UV light. Aromatic ester units can also decrease the melt flow of the thermoplastic composition. On the other hand, the presence of aliphatic ester units can diminish the heat release values. In an embodiment the poly(siloxane-esters), including poly(siloxane-ester-carbonate) copolymers comprise 10 to 50 wt %, 10 to 35 wt %, or 10 to 30 wt % polysiloxane units.

The first repeating units in the poly(siloxane-esters) or poly(siloxane-ester-carbonate)s further contain, in addition to the siloxane blocks of formula (9), repeating units of formula (29)

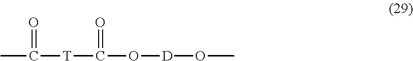

wherein D is a divalent group derived from a dihydroxy compound, and can be, for example, a C₂₋₁₀ alkylene group, a C₆₋₂₀ alicyclic group, a C₆₋₂₀ aryl, or a polyoxyalkylene group in which the alkylene groups contain 2 to 6 carbon atoms, specifically 2, 3, or 4 carbon atoms. In an embodiment, D is a C₂₋₃₀ alkylene having a straight chain, branched chain, or cyclic (including polycyclic) structure. In another embodiment, D is derived from an aromatic dihydroxy compound of formula (3), an aromatic dihydroxy compound of formula (8), or a combination thereof. T in formula (29) is a divalent group derived from a dicarboxylic acid, and can be, for example, a C₂₋₁₀ alkylene group, a C₆₋₂₀ alicyclic group, a C₆₋₂₀ alkyl aromatic group, or a C₆₋₂₀ aromatic group. Examples of aromatic dicarboxylic acids that can be used to prepare the polyester units include isophthalic or terephthalic acid, 1,2-di(p-carboxyphenyl)ethane, 4,4′-dicarboxydiphenyl ether, 4,4′-bisbenzoic acid, and combinations comprising at least one of the foregoing acids. Acids containing fused rings can also be present, such as in 1,4-, 1,5-, or 2,6-naphthalenedicarboxylic acids. Specific dicarboxylic acids are terephthalic acid, isophthalic acid, naphthalene dicarboxylic acid, cyclohexane dicarboxylic acid, or combinations comprising at least one of the foregoing. A specific dicarboxylic acid comprises a combination of isophthalic acid and terephthalic acid wherein the weight ratio of isophthalic acid to terephthalic acid is 100:0 to 0:100, or 99:1 to 1:99, or 91:9 to 2:98.

In another specific embodiment, D is a C₂₋₆ alkylene and T is p-phenylene, m-phenylene, naphthalene, a divalent cycloaliphatic group, or a combination comprising at least one of the foregoing. Alternatively, the ester unit can be an arylate ester unit derived from the reaction of an aromatic dihydroxy compound of formula (8) (e.g., resorcinol) with a combination of isophthalic and terephthalic diacids (or derivatives thereof). In another specific embodiment, the ester unit is derived from the reaction of bisphenol A with a combination of isophthalic acid and terephthalic acid. A specific poly(siloxane-ester-carbonate) comprises siloxane blocks (9), ester units derived from resorcinol and isophthalic and/or terephthalic diacids, and carbonate units (1) derived from resorcinol, bisphenol A, or a combination of resorcinol and bisphenol A in a molar ratio of resorcinol carbonate units to bisphenol A carbonate units of 1:99 to 99:1, specifically 20:80 to 80:20. The molar ratio of ester units to carbonate units in these copolymers can vary broadly, for example 1:99 to 99:1, specifically 10:90 to 90:10, more specifically 25:75 to 75:25, depending on the desired properties of the final composition. Poly(siloxane-ester-carbonate)s of this type can include siloxane blocks (9), and blocks comprising 50 to 99 mol % arylate ester units (e.g., resorcinol ester units) and 1 to 50 mol % aromatic carbonate units including resorcinol carbonate units and optionally bisphenol A carbonate units. Such copolymers are described in U.S. Pat. No. 7,605,221.

Any of the foregoing poly(siloxane) copolymers can have an Mw of 5,000 to 250,000, specifically 10,000 to 200,000 grams per mole (Daltons), even more specifically 15,000 to 100,000 Daltons. As used herein molecular weight is measured by size exclusion gel permeation chromatography (GPC), performed using a Agilent 1200 series GPC equipped with a diode array detector (DAD). Dichloromethane was used as the eluent and the system was calibrated using narrow molecular weight polystyrene standards. GPC samples are prepared at a concentration of 1 mg/ml, and are eluted at a flow rate of 1.5 ml/min.

Melt volume flow rate (often abbreviated “MVR”) measures the rate of extrusion of a poly(siloxane) copolymer through an orifice at a prescribed temperature and load. The foregoing poly(siloxane) copolymers can have an MVR, measured at 300° C. under a load of 1.2 kg, of 0.1 to 200 cubic centimeters per 10 minutes (cm³/10 min), specifically 1 to 100 cm³/10 min.

In some embodiments a combination of two or more different poly(siloxane) copolymers are used to obtain the desired properties. The poly(siloxane) copolymers can differ in one or more of a property (e.g., polydispersity or molecular weight) or a structural feature (e.g., the value of E, the number of blocks of E, or the identity of the first repeating unit). For example, a poly(siloxane-carbonate) having a relatively lower weight percent (e.g., 3 to 10 wt %, or 6 wt %) of relatively longer length (E having an average value of 30-60) can provide a composition of lower colorability, whereas a poly(siloxane-carbonate) having a relatively higher weight percent of siloxane units (e.g., 15 to 25 wt %, or 20 wt %) of the same length siloxane units, can provide better impact properties. As another example, For example, a poly(siloxane-carbonate) having a relatively lower weight percent (e.g., 3 to 10 wt %, or 6 wt %) of relatively longer length (E having an average value of 30-60) can provide a composition of lower colorability, whereas a poly(siloxane-carbonate) having a relatively higher weight percent of siloxane units (e.g., 15 to 25 wt %, or 20 wt %) of the same length siloxane units, can provide better impact properties. Use of a combination of these two poly(siloxane-carbonate)s can provide a composition having both good colorability and impact properties. Similarly, a poly(siloxane-carbonate) can be used with a poly(siloxane-etherimide) to improve impact.

The first polymer, i.e., the poly(siloxane) copolymer, is used with a second brominated polymer, wherein the type and amount of the brominated polymer is selected so as to provide at least 7.8 wt %, or at least 9.0 wt % bromine to the composition as described above. As used herein, a “brominated polymer” is inclusive of homopolymers and copolymers, and includes molecules having at least 2, at least 5, at least 10, or at least 20 repeat units with bromine substitution, and a Mw of at least 1,000 Daltons, for example 1,000 to 50,000 Daltons.

In certain embodiments, the second polymer is a specific brominated polycarbonate, i.e., a polycarbonate containing brominated carbonate units derived from 2,2′,6,6′-tetrabromo-4,4′-isopropylidenediphenol (TBBPA) and carbonate units derived from at least one dihydroxy aromatic compound that is not TBBPA. The dihydroxy aromatic compound can be one of formula (5), (6), (7), (8), (9), or (10). In a specific embodiment the dihydroxy aromatic compound is of formula (5), more specifically dihydroxy aromatic compound (5) containing no additional halogen atoms. In an embodiment, the dihydroxy aromatic compound is Bisphenol A.

The relative ratio of TBBPA to the dihydroxy aromatic compound used to manufacture the TBBPA copolymer will depend in some embodiments on the amount of the TBBPA copolymer used and the amount of bromine desired in the thermoplastic composition. In an embodiment, the TBBPA copolymer is manufactured from a composition having 30 wt % to 70 wt % of TBBPA and 30 to 70 wt % of the dihydroxy aromatic compound, specifically Bisphenol A, or specifically 45 wt % to 55 wt % of TBBPA and 45 wt % to 55 wt % of the dihydroxy aromatic compound, specifically bisphenol A. In an embodiment, no other monomers are present in the TBBPA copolymer.

Combinations of different TBBPA copolymers can be used. Specifically, a TBBPA copolymer can be used having phenol endcaps. Also specifically, a TBBPA carbonate can be used having 2,4,6-tribromophenol endcaps can be used.

The TBBPA copolymers can have a Mw from 18,000 to 30,000 Daltons, specifically 20,000 to 30,000 Daltons as measured by gel permeation chromatography (GPC) using polycarbonate standards.

Alternatively, the poly(siloxane) copolymer is used with a brominated oligomer. Thus, instead of a TBBPA copolymer as the second polymer in certain embodiments, a brominated oligomer having a Mw of 18,000 Daltons or less is used. The term “brominated oligomer” is used herein for convenience to identify a brominated compound comprising at least two repeat units with bromine substitution, and having a Mw of less than 18,000 Daltons. The brominated oligomer can have a Mw of 1,000 to 18,000 Daltons, specifically 2,000 to 15,000 Daltons, and more specifically 3,000 to 12,000 Daltons.

The brominated oligomer has a bromine content of 40 to 60 wt %, specifically 45 to 55 wt %, more specifically 50 to 55 wt %. The specific brominated oligomer and the amount of brominated oligomer are selected to provide at least 7.8 wt % bromine, specifically 7.8 to 14 wt % bromine, more specifically 8 to 12 wt % bromine, each based on the total weight of first polymer, the brominated oligomer, and the optional additional polycarbonate. In other embodiments, the specific brominated oligomer and the amount of brominated oligomer are selected to provide at least 9.0 wt % bromine, specifically 9.0 to 13 wt % bromine based on the total weight of first polymer, the brominated oligomer, and the optional additional polycarbonate.

The brominated oligomer can be a brominated polycarbonate oligomer derived from brominated aromatic dihydroxy compounds (e.g., brominated compounds of formula (1)) and a carbonate precursor, or from a combination of brominated and non-brominated aromatic dihydroxy compounds, e.g., of formula (1), and a carbonate precursor. Brominated polycarbonate oligomers are disclosed, for example, in U.S. Pat. No. 4,923,933, U.S. Pat. No. 4,170,711, and U.S. Pat. No. 3,929,908. Examples of brominated aromatic dihydroxy compounds include 2,2-bis(3,5-dibromo-4-hydroxyphenyl)propane, bis(3,5-dibromo-4-hydroxyphenyl)menthanone, and 2,2′,6,6′-tetramethyl-3,3′,5,5′-tetrabromo-4,4′-biphenol. Examples of non-brominated aromatic dihydroxy compounds for copolymerization with the brominated aromatic dihydroxy compounds include bisphenol A, bis(4-hydroxyphenyl)methane, 2,2-bis(4-hydroxy-3-methylphenyl)propane, 4,4-bis(4-hydroxyphenyl)heptane, and (3,3′-dichloro-4,4′-dihydroxydiphenyl)methane. Combinations of two or more different brominated and non-brominated aromatic dihydroxy compounds can be used. If a combination of aromatic dihydroxy compounds is used, then the combinations can contain 25 to 55 mole percent of the brominated aromatic dihydroxy compounds and 75 to 65 mole percent of a non-brominated dihydric phenol. Branched brominated polycarbonate oligomers can also be used, as can compositions of a linear brominated polycarbonate oligomer and a branched brominated polycarbonate oligomer. Combinations of different brominated copolycarbonate oligomers can be used. Various endcaps can be present, for example polycarbonates having phenol endcaps or 2,4,6-tribromophenol endcaps can be used.

Other types of brominated oligomers can be used, for example brominated epoxy oligomers. Examples of brominated epoxy oligomers include those derived from Bisphenol A, hydrogenated Bisphenol A, Bisphenol-F, Bisphenol-S, novolak epoxies, phenol novolac epoxies, cresol novolac epoxies, N-glycidyl epoxies, glyoxal epoxies dicyclopentadiene phenolic epoxies, silicone-modified epoxies, and epsilon-caprolactone modified epoxies. Combinations of different brominated epoxy oligomers can be used. Specifically, a tetrabromobisphenol A epoxy can be used, having 2,4,6-tribromophenol endcaps. An epoxy equivalent weight of 200 to 3000 can be used.

In some embodiments a combination of two or more different brominated polymers are used to obtain the desired properties. The brominated polymers can differ in one or more of a property (e.g., polydispersity or molecular weight) or a structural feature (e.g., the identity of the repeating units, the presence of copolymer units, or the amount of bromine in the polymer). For example, two different TBBPA copolymers can be used, or a combination of a TBBPA copolymer and a brominated epoxy oligomer. Of course, two or more different poly(siloxane) copolymers can be used with two or more different brominated polymers.

The poly(siloxane) copolymer compositions can further optionally comprise one or more polymers additional to the poly(siloxane) copolymer and the brominated polymer, which can be referred to herein as “one or more third polymers” for convenience. The one or more third polymers can be homopolymers or copolymers and can have repeating units that are the same or different from first repeating units of the poly(siloxane) copolymer. The one or more third polymers can comprise different types of repeating units, provided that the type and amount of repeating units does not significantly adversely affect the desired properties of the compositions, in particular low smoke density and low heat release. The one or more third polymers can comprise carbonate units (1), imide units, etherimide units (17), arylene ether sulfone units (26), arylene ether units (28), ester units (29), or a combination of units comprising at least one of the foregoing. However, in an embodiment, the one or more third polymers do not contain either polysiloxane units or bromine. The one or more third polymers can have a Mw, for example, of 5,000 to 500,000 Daltons, specifically 10,000 to 250,000 Daltons, or 10,000 to 100,000 Daltons, as measured by gel permeation chromatography (GPC), using a crosslinked styrene-divinylbenzene column and calibrated to polycarbonate references. GPC samples are prepared at a concentration of 1 milligrams per milliliters (mg/ml), and are eluted at a flow rate of 1.5 ml/min. The one or more third polymers can have an MVR, measured at 300° C. under a load of 1.2 kg, of 0.1 to 200 cubic centimeters per 10 minutes (cm³/10 min), specifically 1 to 100 cm³/10 min.

The one or more third polymers is selected and used in an amount to provide the desired characteristics to the compositions. The amount of the one or more third polycarbonates can be 0 to 85 wt %, 1 to 80 wt %, 5 to 75 wt %, 8 to 60 wt %, 20 to 50 wt %, or to 40 wt %, based on the total weight of the armature polymer. The third polymer is present in an amount of 8 to 50 wt %, the polysiloxane unit is present in an amount of 1.5 to 3.5 wt %, and the bromine is present in an amount of 7.8 to 13 wt %, each based on the total wt % of the armature polymer.

In the armature polymer comprising a poly(siloxane-carbonate) and the TBBPA copolymer, an optional third polycarbonate can be present that is not the same as the first poly(siloxane-carbonate) or the TBBPA copolymer. Specifically in certain embodiments, the one or more third polymers do not contain either polysiloxane units or bromine. The armature polymer comprising the poly(siloxane-carbonate) and the brominated oligomer, an additional polycarbonate that is not the same as the first poly(siloxane) or the brominated oligomer is present. Specifically, the additional polycarbonate does not contain polysiloxane units or bromine. When the optional one or more third polymer is a polycarbonate, the polymer comprises units of formula (1) as described above, specifically wherein R¹ is derived from the dihydroxy aromatic compound (2) (3), (8), or a combination comprising at least one thereof, and more the specifically dihydroxy aromatic compound (3) containing no additional halogen atoms. Optionally, at least 60%, at least 80%, or at least 90% of the R¹ units are bisphenol A units. The optional one or more third polymer (including the additional polycarbonate) can be a homopolymer with bisphenol A carbonate units. It is also possible for the one or more third polycarbonates or additional polycarbonates to contain units other than polycarbonate units, for example ester units (29), provided that the ester units are selected so as to not significantly adversely affect the desired properties of the poly(siloxane) copolymer compositions as described above. The ester units can be arylate ester unit derived from the reaction of an aromatic dihydroxy compound of formula (8) (e.g., resorcinol) with a combination of isophthalic and terephthalic diacids (or derivatives thereof). Optionally, the ester unit is derived from the reaction of bisphenol A with a combination of isophthalic acid and terephthalic acid. A specific poly(ester-carbonate) comprises ester units derived from resorcinol and isophthalic and/or terephthalic diacids, and carbonate units (1) derived from resorcinol, bisphenol A, or a combination of resorcinol and bisphenol A in a molar ratio of resorcinol carbonate units to bisphenol A carbonate units of 1:99 to 99:1, specifically 20:80 to 80:20. The molar ratio of ester units to carbonate units in these copolymers can vary broadly, for example 1:99 to 99:1, specifically 10:90 to 90:10, more specifically 25:75 to 75:25, depending on the desired properties of the final composition.

In addition to the poly(siloxane) copolymer, brominated polymer, and one or more optional third polymers, the armature compositions can include various additives ordinarily incorporated into flame retardant compositions having low smoke density and low heat release, with the proviso that the additive(s) are selected so as to not adversely affect the desired properties of the poly(siloxane) copolymer composition significantly, in particular low smoke density low heat release. Such additives can be mixed at a suitable time during the mixing of the components for forming the composition. Exemplary additives include fillers, reinforcing agents, antioxidants, heat stabilizers, light stabilizers, plasticizers, lubricants, mold release agents, antistatic agents, colorants such as such as titanium dioxide, carbon black, and organic dyes, surface effect additives, radiation stabilizers, additional flame retardants, and anti-drip agents. A combination of additives can be used. The total amount of additives (other than any filler or reinforcing agents) is generally 0.01 to 25 parts per hundred by weight (PHR) of the armature polymer. Certain additives can be used such as heat stabilizers (including phosphites), other flame retardants (such as Rimar salts) and certain colorants. The armature composition can optionally be free of UV absorbers.

The armature composition comprises carbon black. The carbon black is present in an amount of greater than zero to 0.001 wt %, specifically, 0.000025 wt % to 0.00025 wt %, more specifically, 0.00005 wt % to 0.0001 wt %, still more specifically, 0.000065 wt % to 0.000085 wt %, based upon a total weight of the armature composition.

The use of pigments such as titanium dioxide (TiO₂) produces white compositions, which are commercially desirable. The titanium dioxide can be in any of three modifications of rutile, anatase, and/or brookite, specifically, rutile. Pigments such as titanium dioxide (and/or other mineral fillers) can be present in the armature composition in amounts of 10 to 20 wt %, specifically, 12 wt % to 18 wt %, more specifically, 15 wt %, based upon a total weight of the armature composition. The titanium dioxide can be coated with an organic coating, for example a coating comprising a polysiloxane. For example, the particles can have an organic coating. The average particle size of the titanium dioxide can be less than or equal to 5,000 nm. For example, the average particle size of the titanium dioxide can be less than or equal to 2,000 nm, specifically, less than or equal to 1,000 nm, more specifically, less than or equal to 750 nm, and still more specifically, 100 nm to 550 nm.

Commercially available TiO₂ pigments can be prepared from colloidal suspensions which optionally have low levels of alumina added to chemically passivate the pigment surface. A secondary organic coating, for example an organo-silicone coating, can then be applied to further reduce surface reactivity and improve handling characteristics. Examples of possible coating materials include polysiloxane, trimethylolpropanol (TMP), polysiloxane, and combinations comprising at least one of the foregoing. For example, poly(dimethoxysilane) (PDMS), poly(methylhydrosiloxane) (PHMS), as well as combinations comprising at least one of these materials. Specific examples of suitable titanium dioxide preparations that are commercially available include Tioxide R-FC5 (Huntsman), a small crystal product coated with TMP, PDMS (polydimethylsiloxane) and Al₂O₃; Titafrance RL91, a small crystal product coated with 1.2% PDMS silicone oil; and KRONOS™ 2233 (commercially available from KRONOS™, Inc.), a normal-sized crystal product coated with PDMS polysiloxane and Al₂O₃; and Ti-Pure™ titanium dioxide commercially available from DuPont™.

Exemplary antioxidant additives include organophosphites such as tris(nonyl phenyl)phosphite, tris(2,4-di-t-butylphenyl)phosphite, bis(2,4-di-t-butylphenyl)pentaerythritol diphosphite, distearyl pentaerythritol diphosphite; alkylated monophenols or polyphenols; alkylated reaction products of polyphenols with dienes, such as tetrakis[methylene(3,5-di-tert-butyl-4-hydroxyhydrocinnamate)]methane; butylated reaction products of para-cresol or dicyclopentadiene; alkylated hydroquinones; hydroxylated thiodiphenyl ethers; alkylidene-bisphenols; benzyl compounds; esters of beta-(3,5-di-tert-butyl-4-hydroxyphenyl)-propionic acid with monohydric or polyhydric alcohols; esters of beta-(5-tert-butyl-4-hydroxy-3-methylphenyl)-propionic acid with monohydric or polyhydric alcohols; esters of thioalkyl or thioaryl compounds such as distearylthiopropionate, dilaurylthiopropionate, ditridecylthiodipropionate, octadecyl-3-(3,5-di-tert-butyl-4-hydroxyphenyl)propionate, pentaerythrityl-tetrakis[3-(3,5-di-tert-butyl-4-hydroxyphenyl)propionate; amides of beta-(3,5-di-tert-butyl-4-hydroxyphenyl)-propionic acid, or combinations comprising at least one of the foregoing antioxidants. Antioxidants are used in amounts of 0.01 to 0.1 PHR.

Examples of heat stabilizer additives include organophosphites such as triphenyl phosphite, tris-(2,6-dimethylphenyl)phosphite, tris-(mixed mono- and di-nonylphenyl)phosphite; phosphonates such as dimethylbenzene phosphonate, phosphates such as trimethyl phosphate, or combinations comprising at least one of the foregoing heat stabilizers. Heat stabilizers are used in amounts of 0.01 to 0.1 PHR.

Light stabilizers can also be used. Examples of light stabilizer additives include benzotriazoles such as 2-(2-hydroxy-5-methylphenyl)benzotriazole, 2-(2-hydroxy-5-tert-octylphenyl)-benzotriazole and 2-hydroxy-4-n-octoxy benzophenone, or combinations comprising at least one of the foregoing light stabilizers. Light stabilizers are used in amounts of 0.01 to 5 PHR.

Plasticizers, lubricants, and/or mold release agents can also be present in the armature compositions. There is considerable overlap among these types of materials, which include phthalic acid esters such as dioctyl-4,5-epoxy-hexahydrophthalate; tris-(octoxycarbonylethyl)isocyanurate; tristearin; di- or polyfunctional aromatic phosphates such as resorcinol tetraphenyl diphosphate (RDP), the bis(diphenyl)phosphate of hydroquinone and the bis(diphenyl)phosphate of bisphenol A; poly-alpha-olefins; epoxidized soybean oil; silicones, including silicone oils; esters, for example, fatty acid esters such as alkyl stearyl esters, e.g., methyl stearate, stearyl stearate, pentaerythritol tetrastearate, and the like; combinations of methyl stearate and hydrophilic and hydrophobic nonionic surfactants comprising polyethylene glycol polymers, polypropylene glycol polymers, poly(ethylene glycol-co-propylene glycol) copolymers, or a combination comprising at least one of the foregoing glycol polymers, e.g., methyl stearate and polyethylene-polypropylene glycol copolymer in a solvent; waxes such as beeswax, montan wax, and paraffin wax. Such materials are used in amounts of 0.1 to 1 PHR.

Additional monomeric flame retardants include organic compounds that include phosphorus, bromine, and/or chlorine. Non-brominated and non-chlorinated phosphorus-containing flame retardants can be added for certain applications, for example organic compounds containing phosphorus-nitrogen bonds.

Inorganic flame retardants can also be used, for example salts of C₁₋₁₆ alkyl sulfonate salts such as potassium perfluorobutane sulfonate (Rimar salt), potassium perfluorooctane sulfonate, tetraethylammonium perfluorohexane sulfonate, and potassium diphenylsulfone sulfonate; salts such as Na₂CO₃, K₂CO₃, MgCO₃, CaCO₃, and BaCO₃, or fluoro-anion complexes such as Li₃AlF₆, BaSiF₆, KBF₄, K₃AlF₆, KAlF₄, K₂SiF₆, and/or Na₃AlF₆. When present, inorganic flame retardant salts are present in amounts of 0.01 to 10 PHR, more specifically 0.02 to 1 PHR.

Anti-drip agents in most embodiments are not used in the poly(siloxane) copolymer compositions. Anti-drip agents include a fibril-forming or non-fibril forming fluoropolymer such as polytetrafluoroethylene (PTFE). The anti-drip agent can be encapsulated by a rigid copolymer, for example styrene-acrylonitrile copolymer (SAN). PTFE encapsulated in SAN is known as TSAN. Antidrip agents are substantially absent or completely absent from the armature compositions.

Additional colorants (in addition to titanium dioxide and carbon black) can be used in the thermoplastic compositions. The term “additional colorant” as used herein includes pigments (generally, particulate colorants that can be inorganic or organic) and dyes (generally organic colorants that are soluble in the compositions, including fluorescent compounds), but excludes titanium dioxide and carbon black. The colorant can also have further properties such as electrical conductivity, or may be magnetically shielding. Examples of inorganic pigments are white pigments such as lead white, zinc white, zinc sulfide or lithopones; black pigments such as black iron oxide, iron manganese black or spinel black; chromatic pigments such as chromium oxide, chromium oxide hydrate green, cobalt green or ultramarine green, cobalt blue, iron blue, Milori blue, ultramarine blue or manganese blue, ultramarine violet or cobalt and manganese violet, red iron oxide, cadmium sulfoselenide, molybdate red or ultramarine red; brown iron oxide, mixed brown, spinel phases and corundum phases or chromium orange; yellow iron oxide, nickel titanium yellow, chromium titanium yellow, cadmium sulfide, cadmium zinc sulfide, chromium yellow, zinc yellow, alkaline earth metal chromates, Naples yellow; bismuth vanadate, and effect pigments such as interference pigments and luster pigments. Other specific inorganic pigments include Pigment White 6, Pigment White 7, Pigment Black 7, Pigment Black 11, Pigment Black 22, Pigment Black 27/30, Pigment Yellow 34, Pigment Yellow 35/37, Pigment Yellow 42, Pigment Yellow 53, Pigment Brown 24, Pigment Yellow 119, Pigment Yellow 184, Pigment Orange 20, Pigment Orange 75, Pigment Brown 6, Pigment Brown 29, Pigment Brown 31, Pigment Yellow 164, Pigment Red 101, Pigment Red 104, Pigment Red 108, Pigment Red 265, Pigment Violet 15, Pigment Blue 28/36, Pigment Blue 29, Pigment Green 17, and Pigment Green 26/50. A combination comprising at least one of the foregoing pigments can be used. Pigments, when present, can be used in amounts of up to 0.5 parts per hundred by weight (pph), specifically, 0.001 to 0.5 pph.

Examples of dyes are generally organic materials and include coumarin dyes such as coumarin 460 (blue), coumarin 6 (green), nile red or the like; lanthanide complexes; hydrocarbon and substituted hydrocarbon dyes; polycyclic aromatic hydrocarbon dyes; scintillation dyes such as oxazole or oxadiazole dyes; aryl- or heteroaryl-substituted poly (C₂₋₈) olefin dyes; carbocyanine dyes; indanthrone dyes; phthalocyanine dyes; oxazine dyes; carbostyryl dyes; napthalenetetracarboxylic acid dyes; porphyrin dyes; bis(styryl)biphenyl dyes; acridine dyes; anthraquinone dyes; cyanine dyes; methine dyes; arylmethane dyes; azo dyes; indigoid dyes, thioindigoid dyes, diazonium dyes; nitro dyes; quinone imine dyes; aminoketone dyes; tetrazolium dyes; thiazole dyes; perylene dyes, perinone dyes; bis-benzoxazolylthiophene (BBOT); triarylmethane dyes; xanthene dyes; thioxanthene dyes; naphthalimide dyes; lactone dyes; fluorophores such as anti-stokes shift dyes which absorb in the near infrared wavelength and emit in the visible wavelength, or the like; luminescent dyes such as 7-amino-4-methylcoumarin; 3-(2′-benzothiazolyl)-7-diethylaminocoumarin; 2-(4-biphenylyl)-5-(4-t-butylphenyl)-1,3,4-oxadiazole; 2,5-bis-(4-biphenylyl)-oxazole; 2,2′-dimethyl-p-quaterphenyl; 2,2-dimethyl-p-terphenyl; 3,5,3″″,5″″-tetra-t-butyl-p-quinquephenyl; 2,5-diphenylfuran; 2,5-diphenyloxazole; 4,4′-diphenylstilbene; 4-dicyanomethylene-2-methyl-6-(p-dimethylaminostyryl)-4H-pyran; 1,1′-diethyl-2,2′-carbocyanine iodide; 3,3′-diethyl-4,4′,5,5′-dibenzothiatricarbocyanine iodide; 7-dimethylamino-1-methyl-4-methoxy-8-azaquinolone-2; 7-dimethylamino-4-methylquinolone-2; 2-(4-(4-dimethylaminophenyl)-1,3-butadienyl)-3-ethylbenzothiazolium perchlorate; 3-diethylamino-7-diethyliminophenoxazonium perchlorate; 2-(1-naphthyl)-5-phenyloxazole; 2,2′-p-phenylen-bis(5-phenyloxazole); rhodamine 700; rhodamine 800; pyrene, chrysene, rubrene, coronene, or the like; or combinations comprising at least one of the foregoing dyes. Dyes can be used in amounts of up to 0.05, specifically, 0.00001 to 0.5 phr.

Specific colorants include Solvent Red 135, Solvent Red 52, Pigment Blue 28, Pigment Blue 29:77007, Pigment Blue 60, and Solvent Violet 36.

Compositions used to form light-diffusive articles, for example light-diffusive armatures, can further comprise a light diffuser additive, i.e., a plurality of light-diffusive particles to provide the light-diffusive effect. Such particles are generally insoluble in the polymers of the armature compositions. Light-diffuser additives include silicone particles, e.g., polymethylsilsesquioxanes available from Momentive Performance Materials, Inc., under the trade name Tospearl*, crosslinked poly(methyl methacrylate) (PMMA) and other organic polymer particles, e.g., methyl methacrylate/ethyleneglycol dimethacrylate copolymers available from Sekisui Plastics Co. under the trade name TECHPOLYMER MBS*, low levels of TiO₂. A combination comprising at least one of the foregoing types of light diffuser additives can be used. Such diffuser particles can be added to high clarity or medium clarity compositions to provide light-diffusive compositions, for example in an amount of 0.05 to 10.0 wt %, 0.2 to 3.0 wt %, 0.2 to 2.0 wt %, or 0.25 to 1.00 wt % of the light diffuser additives, based on the total weight of the armature polymers. In general, greater amounts of light diffuser additive is used in the manufacture of thinner articles to obtain the same degree of light diffusion. The light diffuser additives can be silicone particles. The light diffuser additives can also be PMMA. Likewise, the light diffuser additives can be a combination of silicone particles and PMMA particles.

Methods for forming the poly(siloxane) copolymer compositions can vary. In an embodiment, the poly(siloxane) copolymer, brominated polymer, and optional one or more third polymers are combined (e.g., blended) with any additives (e.g., a mold release agent) such as in a screw-type extruder. The poly(siloxane) copolymer, brominated polymer, optional one or more third polymers and any additives can be combined in any order, and in form, for example, powder, granular, filamentous, as a masterbatch, and the like. The armature composition can then be foamed, extruded into a sheet or optionally pelletized. Methods of foaming an armature composition using frothing or physical or chemical blowing agents. The pellets can be used for molding into articles, foaming, or they can be used in forming a sheet of the armature composition. The composition can be extruded (or co-extruded with a coating or other layer) in the form of a sheet and/or can be processed through calendaring rolls to form the desired sheet.

Optionally, the armature compositions can further be formulated to have a hydrogen to carbon ratio of 0.81:1 to 0.88:1.

The armature compositions can further have good melt viscosities which aids processing. The poly(siloxane) copolymer compositions can have a melt volume flow rate (MVR, cubic centimeter per 10 minutes (cc/10 min), according to ASTM D 1238) of greater than or equal to 18 cc/10 min, greater than or equal to 19 cc/10 min, greater than or equal to 20 cc/10 min, measured at 300° C./1.2 kilograms (Kg) at 360 second dwell.

The armature compositions can further have excellent impact strength, particularly when the average value of E is higher, i.e., 25 to 200, 25 to 100, or 25 to 50. Such compositions often have higher siloxane levels, i.e., at least 2.0 wt %, specifically 2.0 to 8 wt %, 2.0 to 5 wt %, 2.0 to 4 wt %, or 2.0 to 3.5 wt %, each based on the total weight of the armature polymer. An article molded from the armature compositions can have a notched Izod impact of greater than 500 μm as measured according to ASTM D 256-10 at a 0.125 inch (3.2 mm) thickness. In some embodiments the articles have 80% or 100% ductility.

In some applications, the armature can have a transparency as measured by % transmission can be up to 5.0%, specifically 0.01% to 3.0%, and more specifically, 0.03 to 1.0%. As used herein, transmission and reflection were measured using an X-Rite Color i7 spectrophotometer with a xenon lamp and integrated sphere on samples of 1 mm thickness, using following conditions: specular component included, D65, 10 degree, 1 mm port. Spectral curves representing the wavelength dependent transmission or reflection of the sample specimen were generated. The spectral curves can be converted into colorimetric values (according to ASTM E308 for CIE system) and reflection and transmission data at a given wavelength.

In yet another embodiment, the impact thermoplastic compositions can be formulated to be medium impact, together with good colorability. For example, a sample molded or formed from a medium impact composition can have a notched Izod impact of greater than or equal to 60 μm² as measured on a 3.2 mm-thick molded article according to ISO 180 at 23° C. Such compositions often have relatively higher siloxane levels, i.e., at least 2.5 wt %, specifically 2.5 to 5.3 wt %, based on the total weight of the polymers in the thermoplastic compositions. These impact values and good colorability can be obtained when the average value of E in the poly(siloxane-carbonate) copolymers is higher, i.e., 25 to 200, 25 to 100, or 25 to 65. For example, a first poly(carbonate-siloxane) copolymer can have average E value of 25 to 200, 25 to 150, or 25 to 65, for example 45 and comprise 15 to 25 wt % siloxane, for example, 20 wt %, based on the weight of the copolymer; and a second poly(carbonate-siloxane) copolymer can have average E value of 25 to 150, specifically 25 to 50, for example 45 and have 4.0 to 10% siloxane, for example 6.0 wt %, based on the weight of the copolymer. The foregoing poly(carbonate-siloxane) copolymers can have carbonate units derived from bisphenol A and poly(siloxane) block units derived from a polysiloxane bisphenol of formula (15), (16), or a combination thereof.

The armature compositions can be used to form a sheet. A “sheet” (which includes a film, layer, and the like) can be shaped or unshaped, and is a molded, formed, or extruded armature of substantially uniform thickness (e.g., 0.001 to 10.0 cm) and which is unshaped or is further shaped. For example in an operation to make a sheet, the molten armature composition (e.g., an armature composition that has been heated to a temperature greater than a glass transition temperature (Tg) of the armature composition) can be extruded from a slot die. Twin or single screw extruders can be used. Single or multi-manifold dies can be used. The extrusion temperatures of 200 to 320° C., specifically 260 to 310° C., and more specifically 270 to 290° C. The molten armature composition can then be passed through a nip (e.g., a space formed between two calendaring rolls), which when cooled can form the sheet. The temperature for the cooling rolls can be the same or different, for example the temperature of the rolls can be from 80 to 175° C., specifically 100 to 160° C., and more specifically 105 to 150° C. After passing through the nip, the armature composition can be cooled (e.g., to a temperature less than the Tg of the armature composition), and can then be passed through pull rolls. A mask can optionally be applied to the cooled sheet to protect the sheet 60 from damage or contamination. The sheet can be cut into lengths suitable for handling.

In various embodiments, the calendaring roll(s) can comprise a polished roll (e.g., a chrome or chromium plated roll) or a textured roll (e.g., a roll comprising an elastomeric material (e.g., an EPDM (ethylene propylene diamine monomer) based rubber)). Suitable materials for the rolls include plastic, metal (e.g., chrome, stainless steel, aluminum, and the like), rubber (e.g., EPDM), ceramic materials, and the like. The size of the rolls, material of the rolls, number of rolls, the film wrap around the rolls, and the like, can vary with the system employed. Processing conditions (e.g., the temperature of the calendaring rolls, the line speed, nip pressure, and the like) can also be varied, depending on the properties of the thermoplastic compositions used.

The sheet can comprise a cap layer to provide additional properties desirable in the sheet. In an embodiment, the cap layer can be a hard coat, defined herein as a coating applied to the sheet to enhance scratch and abrasion resistance, chemical resistance, or other desirable surface properties. Cap layers can also include a UV blocking layer applied to provide optical properties such as enhanced weatherability for underlying layers.

In an embodiment, the sheet comprising the thermoplastic composition further comprises as a cap layer, a hard coat disposed on a surface of the sheet layer. In another embodiment, the sheet comprises a cap layer, a UV blocking layer disposed on a surface of the sheet. Alternatively, a multilayer article comprises the sheet comprising the thermoplastic compositions, a first layer, a UV blocking cap layer disposed on a first side of the sheet, and a second layer, a UV blocking layer cap layer disposed on a second, opposite side of the sheet.

In another embodiment, a multilayer article comprises the sheet comprising the thermoplastic compositions, a first hard coat cap layer disposed on a first side of the sheet, and a second hard coat cap layer disposed on a second, opposite side of the sheet. A first UV blocking layer can optionally further be disposed between the sheet and the first cap layer, and a second UV blocking layer can further be optionally disposed between the opposite side of the sheet and the second hard coat cap layer. Where more than one hard coat or UV blocking cap layer is disposed on the sheet, each layer can be the same or different from the cap layer on the opposing surface.

While any suitable method of forming a multilayer article comprising the thermoplastic composition can be used (e.g., thermoforming, vacuum forming, pressure forming, coextrusion, laminating, profile extrusion, compression molding, injection molding, and the like), in an embodiment the multilayer articles can be formed by coextrusion or thermoforming. The term “thermoforming” refers to a method comprising the sequential or simultaneous heating and forming of a material onto a mold, wherein the material is originally in the form of a sheet, and can then be formed into a desired shape, for example a window. Once the desired shape has been obtained, the formed article (e.g., a component of a marine window) is cooled below its Tg. Thermoforming methods that can be used include mechanical forming (e.g., matched tool forming), membrane assisted pressure/vacuum forming, membrane assisted pressure/vacuum forming with a plug assist, and the like.

Hard coats are manufactured from a hard coat composition that has a hardness after cure that is harder than the hardness of the over-coated article. Desirably, hard coats are also transparent and colorless, and still more desirably, can protect the underlying coated article from exposure to ultraviolet radiation. In an embodiment, the hard coat provides scratch resistance. Hard coats are generally thermosetting, but can be thermoformable or non-thermoformable. A non-thermoformable hard coat can be applied after the article to be hard coated has been shaped to its final shape, whereas a thermoformable hard coat can be applied prior to shaping (e.g., thermoforming, etc.) by coextruding, coating, or other suitable methods, and is subsequently cured to its desired final hardness during or after shaping to form the article. Hard coats can be a single layer hard coat having sufficient scratch resistance. Hard coats comprise curable (i.e., cross-linkable) polymers, and can be based on hydroxy-containing organic polymers such as novolacs, organosilioxane polymers such as polysilsesquioxane copolymers, acrylates, or a combination comprising at least one of the foregoing. Additives can be included in the coating composition and can be included to add or enhance the properties of the hard coat, for example a filler such as silica can be used to increase hardness. Other additives include methyl vinyl cycloalkyl cure retardants which bind the platinum at room temperature to prevent early cure, but release the platinum at higher temperatures to affect cure.

The hard coat composition further comprises a solvent, such as water, or a branched or straight chain C₁₋₁₂ alcohol, ether alcohol, diol, polyol, or ethyl acetate, or other C₁₋₁₂ organic solvent miscible with these alcohols. Once coated, the hard coat layer is dried to form the uncured hard coat, and can be cured thermally.

A primer layer can be disposed on the article to be coated prior to the hard coat layer. Useful primer layers include those based on copolymers comprising C₁₋₁₂ alkyl(meth)acrylates, (meth)acrylic acid, substituted methacrylates such as hydroxyalkyl(meth)acrylates, silane substituted methacrylates including alkoxysilane substituted methacrylates, epoxy-substituted methacrylates, and the like. Other non-(meth)acrylate monomers co-polymerizable with the (meth)acrylate monomers including styrenes, C₂₋₁₂ olefins, C₂₋₁₂ vinyl ethers, C₁₋₁₂ (meth)acrylamides, meth(acrylonitrile), and the like.

Multi-layered shaped articles can alternatively be formed by injection molding the thermoplastic composition onto a single or multi-layer film or sheet substrate as follows: (a) providing a single or multi-layer thermoplastic substrate optionally having a color on the surface, for instance, using screen printing or a transfer dye; (b) conforming the substrate to a mold configuration such as by forming and trimming the substrate into a three-dimensional shape and fitting the substrate into a mold having a surface which matches the three dimensional shape of the substrate; (c) (i) injecting the thermoplastic composition into the mold cavity behind the substrate to produce a one-piece, permanently bonded three-dimensional product or (ii) to transfer a pattern or aesthetic effect from a printed substrate to the injected resin and (d) removing the printed substrate, thus imparting the aesthetic effect to the molded thermoplastic composition.

Those skilled in the art will also appreciate that common curing and surface modification processes including heat-setting, texturing, embossing, corona treatment, flame treatment, plasma treatment, and vacuum deposition can further be applied to the above articles to alter surface appearances and impart additional functionalities to the articles.

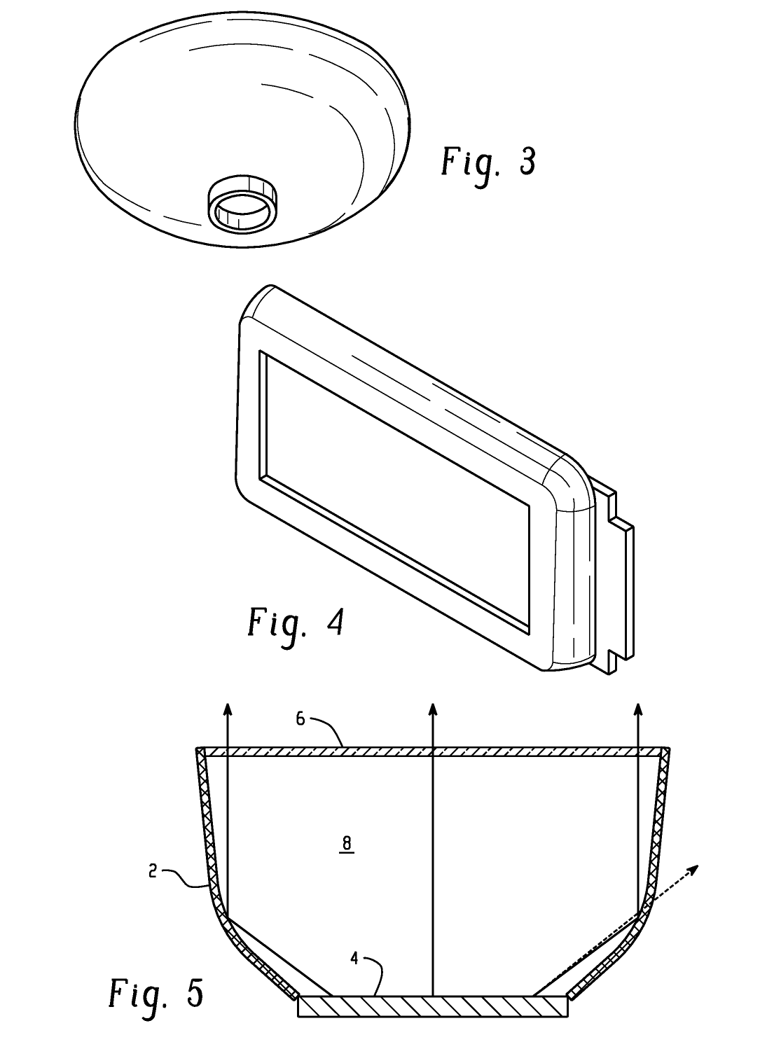

Examples of possible armatures that can be formed from the armature composition are illustrated in FIGS. 2-5. As can be seen from these figures, the armature can have various shapes and sizes, depending upon the specific application and desired use. The light fixture can comprise an armature 2, a light source 4, and a lens 6. The armature 2 and lens 6 can form a cavity 8, wherein the light source 4 can be in the cavity 8.

The disclosure is further illustrated by the following Examples. It should be understood that the non-limiting examples are merely given for the purpose of illustration. Unless otherwise indicated, parts and percentages are by weight based upon the total weight of the poly(siloxane) copolymer, brominated polymer, and optional one or more third polymers in the poly(siloxane) copolymer compositions. The amount of additives is thus given in parts by weight per hundred parts by weight of the resins (PHR).

Some examples of embodiments of the armature and a light fixture are set forth below.

### Embodiment 1

An armature for an illuminant, comprising: walls formed by an armature composition. The armature composition comprises an armature polymer, wherein the armature polymer comprises polycarbonate, 10 wt % to 20 wt % coated titanium dioxide, and greater than zero to 0.001 wt % carbon black, the weight percentages are based upon a total weight of the armature composition. At a thickness of greater than or equal to 3 mm, the armature has a reflection at 700 nm of greater than or equal to 93%.

### Embodiment 2

An armature for an illuminant, comprising: walls formed by an armature composition. The armature composition comprises an armature polymer, wherein the armature polymer comprises 35 to 50 wt % of the bromine-containing polymer based on the total weight of polymers in the thermoplastic polymer composition; and 10 to 65 wt % of the siloxane-containing copolymer based on the total weight of the polymers in the thermoplastic polymer composition, wherein the siloxane-containing copolymer comprises a first repeating unit, and a poly(siloxane) unit having the formula:

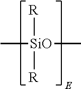

wherein R is each independently a C1-C30 hydrocarbon group, and E has an average value of 5 to 200; 10 wt % to 20 wt % coated titanium dioxide; and greater than zero to 0.001 wt % carbon black, wherein the weight percentages are based upon a total weight of the armature composition.

### Embodiment 3

An armature for an illuminant, comprising: walls formed by an armature composition. The armature composition comprises an armature polymer, wherein the armature polymer comprises a siloxane-containing copolymer in an amount effective to provide a total of 0.2 to 6.5 wt % of siloxane units based on the total weight of the polymers in the thermoplastic polymer composition; a bromine-containing polymer in an amount effective to provide 9 to 13 wt % of bromine, based on the total weight of the polymers in the thermoplastic polymer composition; and optionally a third polymer, wherein the wt % of the siloxane-containing copolymer, the bromine-containing polymer, and the optional third polymer, are based upon the total weight of the armature polymer; 10 wt % to 20 wt % coated titanium dioxide; and greater than zero to 0.001 wt % carbon black; wherein the weight percentages are based upon a total weight of the armature composition.

### Embodiment 4

The armature of any of Embodiments 2-3, wherein, at a thickness of greater than or equal to 3 mm, the armature has a reflection at 700 nm of greater than or equal to 93%.

### Embodiment 5

The armature of any of Embodiments 1-4, wherein the carbon black is in the form of powder.

### Embodiment 6

The armature of any of Embodiments 1-5, wherein the amount of carbon black is 0.000025 wt % to 0.00025 wt %.

### Embodiment 7

The armature of any of Embodiments 1-6, wherein the amount of carbon black is 0.00005 wt % to 0.0001 wt %

### Embodiment 8

The armature of any of Embodiments 1-7, wherein the amount of carbon black is 0.000065 wt % to 0.000085 wt %.

### Embodiment 9

The armature of any of Embodiments 1-8, wherein the armature polymer comprises linear polycarbonate.

### Embodiment 10

The armature of any of Embodiments 1-9, wherein coated titanium dioxide has a coating comprising PDMS.

### Embodiment 11

The armature of any of Embodiments 1-10, wherein coated titanium dioxide has a coating comprising PHMS.

### Embodiment 12

The armature of any of Embodiments 1 or 4-11, wherein the armature polymer comprises: a siloxane-containing copolymer in an amount effective to provide a total of 0.2 to 6.5 wt % of siloxane units based on the total weight of the polymers in the thermoplastic polymer composition; a bromine-containing polymer in an amount effective to provide 9 to 13 wt % of bromine, based on the total weight of the polymers in the thermoplastic polymer composition; and optionally a third polymer, wherein the wt % of the siloxane-containing copolymer, the bromine-containing polymer, and the optional third polymer, are based upon the total weight of the armature polymer.

### Embodiment 13

The armature of any of Embodiments 1 or 4-12, wherein the armature polymer comprises: 35 to 50 wt % of the bromine-containing polymer based on the total weight of polymers in the thermoplastic polymer composition; and 10 to 65 wt % of the siloxane-containing copolymer based on the total weight of the polymers in the thermoplastic polymer composition, wherein the siloxane-containing copolymer comprises a first repeating unit, and a poly(siloxane) unit having the formula:

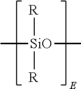

wherein R is each independently a C₁-C₃₀ hydrocarbon group, and E has an average value of 5 to 200.

### Embodiment 14

The armature of any of Embodiments 1-13, wherein armature polymer has a MVR of greater than or equal to 18 cm³/10 min.

### Embodiment 15

The armature of any of Embodiments 1-14, wherein armature polymer has a MVR of greater than or equal to 20 cm³/10 min.

### Embodiment 16

The armature of any of Embodiments 1-15, comprising a reflection of greater than or equal to 94%.

### Embodiment 17

The armature of any of Embodiments 1-16, comprising a percent transmission of up to 5.0%.

### Embodiment 18

The armature of any of Embodiments 1-17, comprising a percent transmission of 0.01% to 3.0%.

### Embodiment 19

The armature of any of Embodiments 1-18, wherein the armature polymer comprises a polycarbonate homopolymer.

### Embodiment 20

The use of the armature of any of Embodiments 1-19 in a light fixture with a light source.

### Embodiment 21

A light fixture, comprising: a light source; the armature of any of Embodiments 1-19, wherein the light source is located in the armature.

### Embodiment 22

The light fixture of Embodiment 21, further comprising a lens in contact with the armature, wherein the armature and lens form a cavity, and wherein the light source is in the cavity.

### Embodiment 23

The light fixture of Embodiment 22, wherein, when in use, light from the light source reflects off of the armature and out of the cavity through the lens.

### Embodiment 24

The light fixture of any of Embodiments 21-23, wherein the light source is in operable communication with the armature such that, when in use, light from the light source reflects off of the armature.

The following examples, are intended to further explain the present armature and not to limit the scope of thereof.

### EXAMPLES

The armature composition set forth in these examples are based upon parts by weight (pbw), wherein the armature composition contains 100 pbw of the armature polymer, and all other levels of ingredients are based on 100 parts by weight of the armature polymer. In addition to the armature polymer, the armature composition comprises titanium dioxide and carbon black.

Following measurements were used:

Reflection and transmission: using an X-Rite Color i7 spectrophotometer with a xenon lamp and integrated sphere on samples of 1 mm thickness, using following conditions: specular component included, D65, 10 degree, 1 mm port. Spectral curves representing the wavelength dependent transmission or reflection of the sample specimen were generated. The spectral curves can be converted into colorimetric values (according to ASTM E308 for CIE system) and reflection and transmission data at a given wavelength.

Melt volume-flow rate (MVR) (ISO1133) at measured at 300° C. under a load of 1.2 kg and 360 second dwell.

Glow: used a light emitting diode (LED) light armature. It is a box with closed sides and different open notches at the top from which the light emits. A color plaque is placed on a notch and the transmission of the light through the plaque is visually observed and rated. The rating was done as following: when light is visible through the plaque, then it is called glow and is indicated with a “+”. When no light is observed then it is indicated with a “−” as shown in Table 1.

An amount of 15 wt % of TiO₂ and 0.5 wt % PETS (pentaerythritol tetrastearate) was added to the total polycarbonate (PC) formulation (set forth in Table 1) and was kept constant in all the formulations as shown in Table 2. Three different types of titanium dioxide (TiO₂ A-C) were used. TiO₂ A (rutile titanium dioxide; Ti-Pure R960 commercially available from DuPont) and TiO₂ B (rutile titanium dioxide; KRONOS™ 2450 commercially available from KRONOS™, Inc.) have an uncoated particle surface, while the particle surface of TiO₂C is coated with poly(dimethoxysilane) (PDMS) and poly(methylhydrosiloxane) (PHMS) (rutile titanium dioxide . . . KRONOS™ 2233, commercially available from KRONOS™, Inc. Combinations were made between TiO₂ A and C, and between TiO₂C and carbon black (CB) (MONARCH™ commercially available from Cabot Corporation).

TABLE 1
PC formulation

| | [symbol] wt % in | | | |
|---|---|---|---|---|
| Grade | formulation | [symbol] M_{w} g/mole | Mₙ | PDI |
| LEXAN ™ 175 | 73.5 | 21,650 | 9,080 | 2.4 |
| LEXAN ™ 105 | 11 | 30,250 | 11,600 | 2.6 |

[symbol]

weight percent (wt %) is based upon the total weight of the composition [symbol]
molecular weight (M_{w} is weight average molecular weight; and Mₙ is number average molecular weight)
PDI = polydispersity index and is calculated using the equation D = M_{w}/Mₙ,

TABLE 2
Reflection at 2.5 mm, MVR and Glow Measurement Results

| | | | | 25 wt % | 50 wt % | 75 wt % | | |
|---|---|---|---|---|---|---|---|---|
| | | | | TiO₂ C | TiO₂ C | TiO₂ C | TiO₂ C | TiO₂ C |
| | TiO₂ A | TiO₂ B | TiO₂ C | 75 wt % | 50 wt % | 25 wt % | CB | CB |
| | 100 wt % | 100 wt % | 100 wt % | TiO₂ A | TiO₂ A | TiO₂ A | 0.0001 | 0.000075 |
| Particle Size | ~500 | 180 | 180 | | | | | |
| (mm) | | | | | | | | |
| Reflection % | | 96.83 | 95.67 | 97.16 | 97.23 | 97.03 | 94.70 | 95.5 |
| at 700 nm | | | | | | | | |
| MVR | | | 19.4 | 129 | 41.8 | 26.7 | 19.8 | 20.5 |
| cm³/10 min | | | | | | | | |
| Glow (1 mm) | ++ | ++++ | ++++ | +++ | ++++ | ++++ | ++ | +++ |
| Glow (2 mm) | + | ++ | +++ | ++ | +++ | +++ | + | 66 |
| Glow (3 mm) | − | + | ++ | + | ++ | ++ | ± | + |
| Glow (4 mm) | −− | ± | + | ± | + | + | − | − |
| Transmission | * | 0.62 | 0.60 | 0.67 | 0.71 | 0.70 | 0.44 | 0.49 |
| at 1 mm and | | | | | | | | |
| 700 nm (%) | | | | | | | | |

wt % TiO₂ is based upon the total weight of TiO₂
* Only 1 plaque and destroyed at the 1 mm area

The MVR value could not be determined for the uncoated TiO₂ A and B, due to degradation of the armature polymer (e.g., the polycarbonate (PC)), e.g., caused by the surface reactivity of the TiO₂ with the polycarbonate. Degradation was so severe in the case of TiO₂ A that it was impossible to mold a plaque and measure the reflection. Due to the coating at the particle surface of TiO₂C, the reactivity was not present and no degradation of the polycarbonate occurred since the MVR value (19.4 cm³/10 min) is as expected.

As can be clearly seen below in Table 3, using carbon black in the formulation lead to a stable formulation and resulted in a reflection over 90%, specifically greater than 92%, and more specifically greater than 94% and no glow at 3 mm.

TABLE 3
Reflection and Transmission Data at Different Carbon
Black (CB) Loadings, Measured at 1 mm Thickness

| CB (wt %) | Reflection (%) at 700 nm | Transmission (%) at 700 nm |
|---|---|---|
| 0 | 96.33 | 1.11 |
| 0.0001 | 94.70 | 0.55 |
| 0.00025 | 92.67 | 0.23 |
| 0.001 | 87.54 | 0.04 |

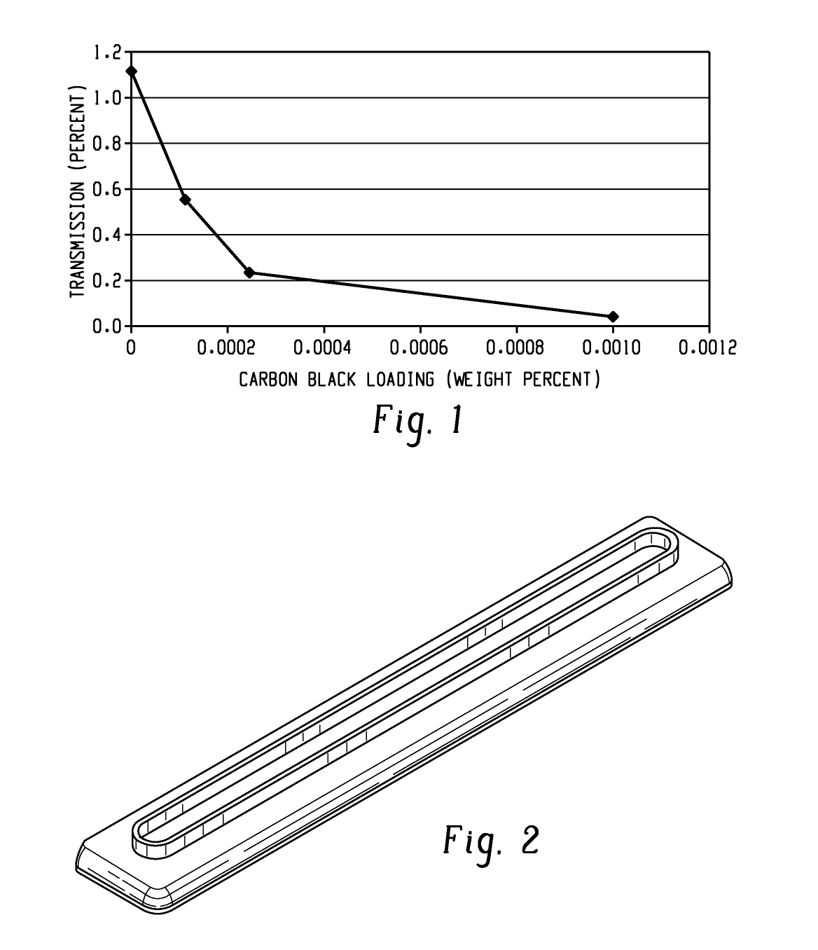

This data suggest that there is an exponential trend between CB loading and transmission as can be observed in FIG. 1.

Ranges disclosed herein are inclusive and combinable (e.g., ranges of “up to 25 wt %, or, more specifically, 5 wt % to 20 wt %,” is inclusive of the endpoints and all intermediate values of the ranges of “5 wt % to 25 wt %,” etc.). “Combination” is inclusive of compositions, blends, mixtures, alloys, reaction products, and the like. Furthermore, the terms “first,” “second,” and the like do not denote any order, quantity, or importance, but rather are used to distinguish one element from another, and the terms “a” and “an” herein do not denote a limitation of quantity, but rather denote the presence of at least one of the referenced item. Reference throughout the specification to “an embodiment”, “another embodiment”, “an embodiment,” and so forth, means that a particular element (e.g., feature, structure, and/or characteristic) described in connection with the embodiment is included in at least an embodiment described herein, and can or cannot be present in other embodiments. In addition, it is to be understood that the described elements can be combined in any suitable manner in the various embodiments. The suffix “(s)” as used herein is intended to include both the singular and the plural of the term that it modifies, thereby including at least one of that term (e.g., the colorant(s) includes at least one colorants).

In general, the invention may alternately comprise, consist of, or consist essentially of, any appropriate components herein disclosed. The invention may additionally, or alternatively, be formulated so as to be devoid, or substantially free, of any components, materials, ingredients, adjuvants or species used in the prior art compositions or that are otherwise not necessary to the achievement of the function and/or objectives of the present invention.

Compounds are described using standard nomenclature. For example, any position not substituted by any indicated group is understood to have its valency filled by a bond as indicated, or a hydrogen atom. A dash (“-”) that is not between two letters or symbols is used to indicate a point of attachment for a substituent. For example, —CHO is attached through carbon of the carbonyl group. The term “alkyl” includes both C₁₋₃₀ branched and straight chain, unsaturated aliphatic hydrocarbon groups having the specified number of carbon atoms. Examples of alkyl include, but are not limited to, methyl, ethyl, n-propyl, i-propyl, n-butyl, s-butyl, t-butyl, n-pentyl, s-pentyl, n- and s-hexyl, n- and s-heptyl, and, n- and s-octyl. The term “aryl” means an aromatic moiety containing the specified number of carbon atoms, such as to phenyl, tropone, indanyl, or naphthyl. The term “hydrocarbon group” encompasses groups containing the specified number of carbon atoms and having carbon, hydrogen, and optionally one to three heteroatoms selected from O, S, P, and N. Hydrocarbon groups can contain saturated, unsaturated, or aromatic moieties, or a combination comprising any of the foregoing, e.g., an alkyl moiety and an aromatic moiety. Hydrocarbon groups can be halogenated, specifically chlorinated, brominated, or fluorinated, including perfluorinated. The term “aromatic group” includes groups having an aromatic moiety, optionally together with a saturated or unsaturated moiety.

All cited patents, patent applications, and other references are incorporated herein by reference in their entirety. However, if a term in the present application contradicts or conflicts with a term in the incorporated reference, the term from the present application takes precedence over the conflicting term from the incorporated reference.

While the invention has been described with reference to embodiments, it will be understood by those skilled in the art that various changes can be made and equivalents can be substituted for elements thereof without departing from the scope of the invention. In addition, many modifications can be made to adapt a particular situation or material to the teachings of the invention without departing from essential scope thereof. Therefore, it is intended that the invention not be limited to the particular embodiment disclosed as the best mode contemplated for carrying out this invention, but that the invention will include all embodiments falling within the scope of the appended claims.

1. An armature for an illuminant, comprising:
walls formed by an armature composition, wherein the armature composition comprises
an armature polymer, wherein the armature polymer comprises polycarbonate;
10 wt % to 20 wt % coated titanium dioxide; and
greater than zero to 0.001 wt % carbon black;
wherein the weight percentages are based upon a total weight of the armature composition;
wherein, at a thickness of greater than or equal to 3 mm, the armature has a reflection at 700 nm of greater than or equal to 93%.

2. The armature of claim 1, wherein, at a thickness of greater than or equal to 3 mm, the armature has a reflection at 700 nm of greater than or equal to 93%.

3. The armature of claim 1, wherein the carbon black is in the form of powder.

4. The armature of claim 1, wherein the amount of carbon black is 0.000025 wt % to 0.00025 wt %.

5. The armature of claim 1, wherein the amount of carbon black is 0.00005 wt % to 0.0001 wt %

6. The armature of claim 1, wherein the amount of carbon black is 0.000065 wt % to 0.000085 wt %.

7. The armature of claim 1, wherein the armature polymer comprises linear polycarbonate.

8. The armature of claim 1, wherein coated titanium dioxide has a coating comprising PDMS.

9. The armature of claim 1, wherein coated titanium dioxide has a coating comprising PHMS.

10. The armature of claim 1, wherein the armature polymer comprises
a siloxane-containing copolymer in an amount effective to provide a total of 0.2 to 6.5 wt % of siloxane units based on the total weight of the polymers in the thermoplastic polymer composition;
a bromine-containing polymer in an amount effective to provide 9 to 13 wt % of bromine, based on the total weight of the polymers in the thermoplastic polymer composition; and
optionally a third polymer, wherein the wt % of the siloxane-containing copolymer, the bromine-containing polymer, and the optional third polymer, are based upon the total weight of the armature polymer.

11. The armature of claim 1, wherein the armature polymer comprises
35 to 50 wt % of the bromine-containing polymer based on the total weight of polymers in the thermoplastic polymer composition; and
10 to 65 wt % of the siloxane-containing copolymer based on the total weight of the polymers in the thermoplastic polymer composition, wherein the siloxane-containing copolymer comprises a first repeating unit, and a poly(siloxane) unit having the formula: 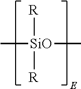
wherein R is each independently a C₁-C₃₀ hydrocarbon group, and E has an average value of 5 to 200.

12. The armature of claim 1, wherein armature polymer has a MVR of greater than or equal to 18 cm³/10 min.

13. The armature of claim 1, wherein armature polymer has a MVR of greater than or equal to 20 cm³/10 min.

14. The armature of claim 1, comprising a reflection of greater than or equal to 94%.

15. The armature of claim 1, comprising a percent transmission of up to 5.0%.

16. The armature of claim 1, comprising a percent transmission of 0.01% to 3.0%.

17. The armature of claim 1, wherein the armature polymer comprises a polycarbonate homopolymer.

18. An armature for an illuminant, comprising:
walls formed by an armature composition, wherein the armature composition comprises
an armature polymer, wherein the armature polymer comprises
35 to 50 wt % of the bromine-containing polymer based on the total weight of polymers in the thermoplastic polymer composition; and
10 to 65 wt % of the siloxane-containing copolymer based on the total weight of the polymers in the thermoplastic polymer composition, wherein the siloxane-containing copolymer comprises a first repeating unit, and a poly(siloxane) unit having the formula: 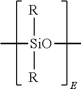
wherein R is each independently a C₁-C₃₀ hydrocarbon group, and E has an average value of 5 to 200; and
10 wt % to 20 wt % coated titanium dioxide; and
greater than zero to 0.001 wt % carbon black;
wherein the weight percentages are based upon a total weight of the armature composition.

19. An armature for an illuminant, comprising:
walls formed by an armature composition, wherein the armature composition comprises
an armature polymer, wherein the armature polymer comprises
a siloxane-containing copolymer in an amount effective to provide a total of 0.2 to 6.5 wt % of siloxane units based on the total weight of the polymers in the thermoplastic polymer composition;
a bromine-containing polymer in an amount effective to provide 9 to 13 wt % of bromine, based on the total weight of the polymers in the thermoplastic polymer composition; and
optionally a third polymer, wherein the wt % of the siloxane-containing copolymer, the bromine-containing polymer, and the optional third polymer, are based upon the total weight of the armature polymer; and
10 wt % to 20 wt % coated titanium dioxide; and
greater than zero to 0.001 wt % carbon black;
wherein the weight percentages are based upon a total weight of the armature composition.

20. A light fixture, comprising:
a light source;
the armature of claim 19, wherein the light source is located in the armature.

21. The light fixture of claim 20, further comprising a lens in contact with the armature, wherein the armature and lens form a cavity, and wherein the light source is in the cavity.
